(19) United States
(12) Patent Application Publication
(10) Pub. No.: US 2026/0369629 A1
(43) Pub. Date: Nov. 19, 2026

(54) LITHIUM-ION BATTERY ANODE MATERIAL MEMBER, MANUFACTURING METHOD OF FRAME STRUCTURE SERVING AS CORE, LITHIUM-ION BATTERY ANODE MATERIAL AND MANUFACTURING METHOD THE SAME, AND LITHIUM-ION BATTERY ANODE INCLUDING THE LITHIUM-ION BATTERY ANODE MATERIAL

(71) Applicant: 3DC Inc., Sendai-shi, Miyagi (JP)

(72) Inventors: Atsuo OMARU, Miyagi (JP); Ginga NISHIKAWA, Miyagi (JP)

(21) Appl. No.: 19/480,202

(22) PCT Filed: Dec. 6, 2024
(86) PCT No.: PCT/JP2024/043298

§ 371 Date: Oct. 30, 2025

(30) Foreign Application Priority Data
Dec. 7, 2023 (JP) 2023-207317

(51) Int. Cl. H01M 4/80; H01M 4/02; H01M 4/04; H01M 4/66; H01M 10/0525

(52) U.S. Cl. CPC H01M 4/808; H01M 4/0428; H01M 4/0471; H01M 4/663; H01M 10/0525; H01M 2004/021

(57) ABSTRACT

Provided are a lithium-ion battery anode material member, a manufacturing method of a frame structure serving as a core, a lithium-ion battery anode material and a manufacturing method thereof, and a lithium-ion battery anode including the lithium-ion battery anode material that can provide a lithium-ion battery having a high capacity and a high charge and discharge reversibility. The lithium-ion battery anode material member is a carbon material forming a frame structure serving as a core, and the surface of the frame of the frame structure has a pore that is a through hole or a bottomed hole. The frame structure is used as a frame arranged inside silicon of the lithium-ion battery anode material. In the lithium-ion battery anode material, the frame structure that is a carbon material is arranged inside silicon.

### TECHNICAL FIELD

The present invention relates to a lithium-ion battery anode material member, a manufacturing method of a frame structure serving as a core, a lithium-ion battery anode material and a manufacturing method the same, and a lithium-ion battery anode including the lithium-ion battery anode material.

### BACKGROUND ART

Lithium-ion batteries have expanded their applications across a wide range, such as smartphones, electric vehicles (EVs), and the like since the birth thereof. As a result, in manufacturing of lithium-ion batteries, there is a continuing demand for higher performance in the market along with cost competitiveness. In preserving the global environment, an increase in the EVs driving range is one of the necessary conditions for electric vehicles, which less discharge carbon dioxide (CO₂), to replace gasoline-powered vehicles.

In terms of characteristics of lithium-ion batteries, there is a demand for an increase in the capacity of the lithium-ion batteries. Patent Literature 1 discloses a non-aqueous electrolyte solution secondary battery in which a support of an anode active material (lithium) is formed from silicon monocrystals in order to address a problem of a smaller capacity per weight in anode current collectors with lead or a lead alloy.

An increase in the capacity of lithium-ion batteries is made possible by controlling the quantity of lithium ions included in the material of a cathode incorporated in a battery during a manufacturing phase. To achieve this, there are challenges of providing a high-capacity anode that can receive lithium ions from the cathode so as not to be an overcharged state and ensuring charge and discharge reversibility of cathode and anode materials that repeat transfer of such a quantity of lithium ions (as an example, Patent Literature 2).

### CITATION LIST

### Patent Literature

[PTL 1]

Japanese Patent Application, Publication No. H5-74463

[PTL 2]

Japanese Patent Application, Publication No. H7-29602

### SUMMARY OF INVENTION

### Technical Problem

For anode materials, graphite-based materials made of carbon have been widely used in terms of stable supply availability, cost, and quality as an industrial product. On the other hand, it is apparent that the generally used graphite-based materials reached a theoretical limit for the demand for an increase in the capacity described above.

As an alternative to graphite-based materials, anode materials containing silicon or tin using an electrochemical lithium alloying reaction are introduced into a part of the market. The anode materials containing silicon or tin have a particularly large amount of lithium combined, have low toxicity, and are readily available. Because of high manufacturing costs or insufficient performance, however, the product life thereof was not so long. Although various improvements have been attempted as a lithium alloy-based material for materials with silicon that have been widely spread in the world in various applications such as semiconductor materials, silicone resins, or the like, these materials have not reached a level of graphite-based materials in terms of practicality.

In a lithium alloying reaction, silicon and lithium are bound due to transfer of electrons, the binding phase spreads in particles or the like, and crystal lattices expand causing volumetric expansion of the silicon portion. This is one of the factors that inhibit the charge and discharge reversibility of lithium-ion batteries.

Specifically, in an alloying reaction between lithium and silicon occurring in an initial charge phase, volumetric expansion can proceed smoothly to some degrees. However, when lithium is released from silicon in a later phase, the battery may be unable to follow the contraction due to the stiffness of silicon. In such a case, contact between silicon, a conductive agent, and a current collector involved in charging and discharging is disconnected, electron conduction is lost, and this results in a state where lithium remains during discharging or a state where subsequent charging is not possible. When this is repeated, an increase in resistance and inactivation are also repeated combined with a reaction with an electrolyte solution. As a result, the anode is deteriorated, and the life of the battery is also reduced.

The present invention has been made in view of such circumstances and intends to provide a lithium-ion battery anode material member, a manufacturing method of a frame structure serving as a core, a lithium-ion battery anode material and a manufacturing method thereof, and a lithium-ion battery anode including the lithium-ion battery anode material that can provide a silicon-based lithium-ion battery having a high capacity and a high charge and discharge reversibility.

### Solution to Problem

To solve the above problem, a lithium-ion battery anode material member, a manufacturing method of a frame structure serving as a core, a lithium-ion battery anode material and a manufacturing method thereof, and an anode including a lithium-ion battery anode material of the present invention employ the following solutions.

The first aspect of the present invention provides a lithium-ion battery anode material member used for a frame arranged inside silicon of a lithium-ion battery anode material, the anode material member is a carbon material forming a frame structure serving as a core (core frame; hereafter, also referred to as “CF”), and a surface of a frame of the frame structure has a pore, the pore being a through hole or a bottomed hole.

In the above first aspect, the frame structure may comprise at least one of a carbonaceous substance, a graphene substance, and a thin-layer graphene substance.

In the above first aspect, the frame structure may comprise at least one of a plate-like shape, a curved face shape, and an irregular surface shape.

In the above first aspect, the frame structure may be particles, and the average particle diameter of the particles may be greater than or equal to 1.3 μm and less than or equal to 10.5 μm.

In the above first aspect, the effective spatial index defined as the pore volume of the frame structure divided by an oil absorption value may be 1.5 to 10.5.

In the above first aspect, at least a part of the frame structure may comprise spherical or substantially spherical particles.

In the above first aspect, the frame structure maybe particles, and the average aspect ratio of the particles may be 1 to 5.

In the above first aspect, the frame structure may be formed of at least one of carbon meso-sponge and graphene meso-sponge.

The second aspect of the present invention provides a manufacturing method of a frame structure serving as a core formed of a carbon material, the manufacturing method including steps of: arranging ceramic particles serving as a template; circulating organic hydrocarbon and coating a carbon layer or a graphene layer on a surface of the ceramic particles by a chemical vapor deposition (CVD) method; dissolving and eluting the ceramic particles with acid and forming a frame structure precursor having an intraparticle space; and applying heat treatment to the obtained frame structure precursor and obtaining a frame structure. The surface of a frame of the manufactured frame structure has a pore, the pore being a through hole or a bottomed hole.

In the above second aspect, each of the ceramic particles may include a pore inside.

In the above second aspect, the manufacturing method may further include a step of granulating each of the ceramic particles into a substantially spherical shape before the step of coating the carbon layer or the graphene layer.

In the above second aspect, the step of applying heat treatment to the obtained frame structure precursor may not be performed.

In the above second aspect, a pore compression process may be performed after the step of obtaining the frame structure.

The third aspect of the present invention provides a lithium-ion battery anode material including: silicon; and a frame structure serving as a core arranged inside the silicon, and the frame structure is formed of a carbon material, and a surface of a frame of the frame structure has a pore, the pore being a through hole or a bottomed hole.

In the above third aspect, at least a part of the frame structure may be interposed by silicon.

In the above third aspect, the silicon may include silicon oxide. The silicon oxide may be, as examples, SiO, SiO₂, a mixture of Si and SiO₂, Si₃O₂, or the like. The composition of the silicon oxide may be expressed by SiₓO_{y}, as an example, and x may be 1 to 3, and y may be 1 to 2.

In the above third aspect, the lithium-ion battery anode material may have one or more barrier layers outside the surface of the silicon site, the barrier layers comprising any of a carbonaceous substance, a graphene substance, and a thin-layer graphene substance.

In the above third aspect, the lithium-ion battery anode material may have a void (barrier layer void; hereafter, also referred to as “BLV”) between the barrier layer and the outer surface of the silicon site.

The fourth aspect of the present invention provides a manufacturing method of lithium-ion battery anode material including steps of: arranging a frame structure serving as a core in a reaction container, the frame structure being a carbon material; and circulating a compound containing silicon at 300 °C to 900 °C in the reaction container and depositing silicon on an outer surface of the core frame structure by a CVD method. The surface of the frame of the frame structure has a pore that is a through hole or a bottomed hole. The temperature at which a compound containing silicon is circulated may be 400 °C, 450 °C, 500 °C, 600 °C, 700 °C, or 800 °C.

In the above fourth aspect, the compound containing silicon may include silane (SiH₄).

In the above fourth aspect, a gas of the compound containing silicon may be diluted with an inert gas.

In the above fourth aspect, the manufacturing method may further have steps of: after the step of arranging the frame structure, vacuum-suctioning the reaction container into a vacuum state; and raising the temperature of the reaction container to a temperature at which a CVD reaction is performed, and CVD may be performed after a mixed gas of a gaseous silane diluted with an inert gas is introduced into the reaction container under the vacuum state.

In the above aspect, the CVD may be performed while the mixed gas is circulated.

In the above fourth aspect, one or more barrier layers comprising any of a carbonaceous substance, a graphene substance, and a thin-layer graphene substance may be formed outside the surface of the deposited silicon.

In the above fourth aspect, the manufacturing method may further include steps of: heating the frame structure at 200 °C to 500 °C in an atmosphere containing at least oxygen after depositing silicon on the outer surface of the frame structure to contain oxide in the silicon; replacing content in the reaction container with an inert gas; and forming a barrier layer on outside of the surface of silicon containing the oxide under circulation of a gas of a compound containing carbon, the barrier layer comprising any of a carbonaceous substance, a graphene substance, and a thin-layer graphene substance.

In the above fourth aspect, the manufacturing method may further include steps of: providing an oxide layer on the outer surface of the deposited silicon after the step of depositing silicon on the outer surface of the frame structure; forming a barrier layer on the outer surface of the oxide layer by a CVD method using a hydrocarbon gas, the barrier layer comprising any of a carbonaceous substance, a graphene substance, and a thin-layer graphene substance; and forming a-void layer between the barrier layer and the outer surface of the deposited silicon by dissolving and eluting the oxide layer with acid.

The fifth aspect of the present invention provides a lithium-ion battery anode containing the lithium-ion battery anode material according to the above third aspect.

### Advantageous Effects of Invention

The anode material according to the present invention has a frame structure serving as a core formed of a carbon material inside silicon. The flexibility of the frame structure can mitigate an adverse effect of volumetric expansion and contraction caused by charge and discharge reactions between lithium and silicon, and the conductivity thereof can suppress a side reaction due to overvoltage during charging and discharging, which makes it possible to obtain an anode material having a high capacity and a long life. Further, by employing an anode containing such an anode material, it is possible to obtain a lithium-ion battery having a high capacity and a long life.

### BRIEF DESCRIPTION OF DRAWINGS

FIG. 1 is a TEM photograph representing an example of the structure of a lithium-ion battery anode material according to one embodiment of the present invention.

FIG. 2 is a diagram illustrating an example of the sectional structure of a lithium-ion battery having an anode containing a lithium-ion battery anode material according to one embodiment of the present invention.

FIG. 3 is a TEM photograph of a core frame structure (CF) obtained in Example 1.

FIG. 4A is a diagram illustrating a pore distribution of magnesium oxide nano-powder that is a template.

FIG. 4B is a diagram illustrating a pore distribution of the obtained CF.

FIG. 5 is a TEM image photograph of a lithium-ion battery anode material in which silicon has been deposited to the CF obtained in Example 1.

FIG. 6A is a SEM image photograph of a CF obtained in Example 2.

FIG. 6B is a high-resolution SEM image photograph the surface of the CF obtained in Example 2.

FIG. 6C is an ultrahigh-resolution TEM image photograph of the CF obtained in Example 2.

FIG. 7 is a TEM image photograph of a CFSI anode material obtained in Example 2.

FIG. 8 is a TEM image photograph of an Si anode material obtained in Comparative example 1.

FIG. 9 is a TEM image photograph of carbon black of Comparative example 1.

FIG. 10 is a TEM image photograph of a CFSI anode material obtained in Example 10.

FIG. 11 is a TEM image photograph of a CFSI anode material obtained in Example 11.

FIG. 12 is an SEM image photograph of a CF obtained in Example 14.

### DESCRIPTION OF EMBODIMENTS

One embodiment of a lithium-ion battery anode material member, a manufacturing method of a frame structure serving as a core, a lithium-ion battery anode material and a manufacturing method thereof, and a lithium-ion battery anode including the lithium-ion battery anode material of the present invention will be described below with reference to the drawings.

### 1. Lithium-Ion Battery Anode Material

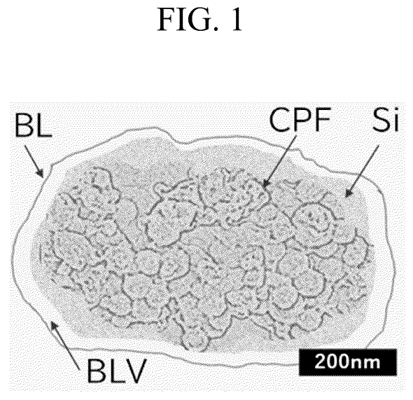

FIG. 1 illustrates an example of the structure of the lithium-ion battery anode material of the present embodiment. The lithium-ion battery anode material of the present embodiment has structure in which silicon (Si) is deposited on the surface of a frame structure in a space of the frame structure serving as a core (CF). Silicon enters not only the outside of the frame structure but also the space existing inside the frame structure. The frame structure of the present embodiment functions as a lithium-ion battery anode material member. In FIG. 1, “CF” represents a frame structure, “Si” represents silicon, “BL” represents a barrier layer, and “BLV” represents a barrier layer void, which will be described below in order.

### 2. Frame Structure Serving as a Core (CF)

In the present embodiment, the frame structure serving as a core is referred to as a core frame (hereafter, also referred to as “CF”). The CF has a nano-scale space inside the frame structure. Silicon is subdivided into nano-scale to exist in the space existing inside the lithium-ion battery anode material of the present embodiment. Subdividing silicon to be present is for minimizing the impact of the structural destruction on the anode material due to charging and discharging caused when used as a lithium-ion battery. This frame structure is formed of a carbon material. The three-dimensional coupling of the carbon materials forming the frame structure is made of at least one of carbon-carbon covalent bond, hydrogen bond, and physical contact between core frames. As an example, a plate-like carbon pieces are three-dimensionally coupled to form a frame structure.

While any inorganic compounds such as metals can be used for the frame structure as long as they satisfy the requirement, carbon materials are preferably used in terms of conductivity or light weight. It is preferable to use a flexible graphene substance as the carbon material in order to follow a change in the form caused by expansion and contraction of the anode material during use of the lithium-ion battery. It is more preferable to use a thin-layer graphene substance with a small number of layers stacked. The frame structure is formed of at least one of a plate-like shape, a curved surface shape, and an irregular surface shape.

Graphene has a single layer of sheet-like structure obtained as a result of planar growth of a carbon hexagonal network surface in which benzene rings are bound. Graphite is multi-layered graphene. On the other hand, a structure that is elastically deformable due to a small number of layers while a carbon hexagonal network surface has been planarly grown is defined as a thin-layer graphene substance in the present specification. Graphene is a carbonaceous substance having high electron conductivity due to highly regular planar structure.

The CF of the present embodiment is formed as a particulate substance formed of three-dimensionally coupled primary particles and secondary particles. When a stress is loaded to the CF including a graphene substance or a thin-layer graphene substance, the three-dimensional shape of the thin-layer graphene substance portion is mainly deformed and compressed in the primary particles and the secondary particles. However, when the loaded stress is unloaded, the deformed portion is restored at a certain rate due to the elastic deformability thereof. The portion not restored even when unloaded is a portion having low elasticity. When the portion made of the thin-layer graphene substance includes many structural defects or includes many amorphous bonds, the shape is not restored, that is, the portion is plastically deformable to stress. Such a structural part that is plastically deformable to stress exhibits a high strength against stress or has a nature of being easily deformed and not restored thereafter.

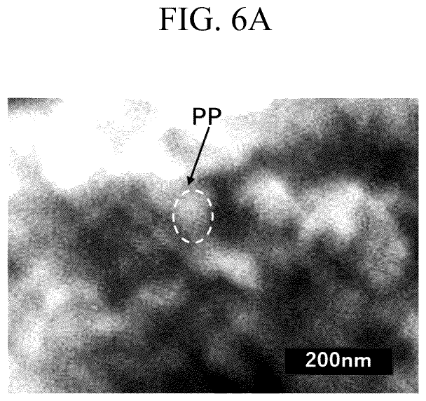

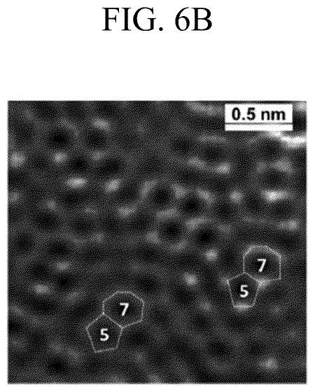

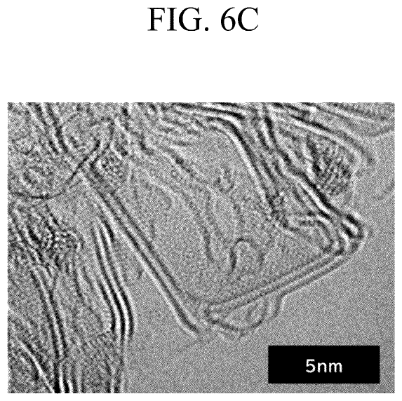

The primary particle (hereafter, also denoted to as “PP”) is a hollow particle having a three-dimensional frame and having an internal space. The secondary particle is formed of a plurality of primary particles adhered to each other. FIG. 6A is a photograph of an enlarged part of an example of the secondary particle. In other words, the entirety of FIG. 6A illustrates the structure of a secondary particle. In FIG. 6A, a portion surrounded by the dash-dot line corresponds to a primary particle.

The carbon material of the present embodiment may include a graphene substance as the carbonaceous substance. Graphene taking a single plate-like structure has the structure formed of only a two-dimensional plate. In contrast, carbon meso-sponge (hereafter, also referred to as “CMS”) or graphene meso-sponge (hereafter, also referred to as “GMS”) takes the frame structure enclosing a three-dimensional nano-size space and thus is preferable for the CF of the present invention. The CMS of the present embodiment is a structure formed after coating a carbon layer or a graphene layer on template ceramic particles containing fine pores by CVD or the like, then dissolving and eluting the ceramic particles, which are templates, with acid, and washing the ceramic particles. The CMS after subjected to high-temperature treatment is the GMS.

With respect to GMS, an oxygen-containing functional group or the like are dissociated by being subjected to high-temperature treatment, at the same time, carbon radicals at the ends of a six-membered ring are bound to each other, and GMS structure connecting defects is made. Accordingly, distinctive physical properties such as flexibility caused by the graphene structure are exhibited. In contrast, while the structural defect remains in CMS not subjected to high-temperature treatment, existing oxygen-containing functional group serves as the starting point of a reaction with a silane gas and more easily permeates inside the CF for some reaction conditions, which may be preferable in terms of a larger amount of silicon deposition as a result. Thus, for some performance of a required silicon-based anode material, the CF not subjected to high-temperature treatment can also be used preferably.

As described above, in the anode material member of the present embodiment, a portion of the graphene substance or the thin-layer graphene substance is elastically deformable, and the portion other than the graphene substance or the thin-layer graphene substance is an amorphous carbon and is plastically deformable. The primary particles of the anode material member of the present embodiment are deformed when loaded with stress. For a certain level of loaded stress, while the shape of some of the plurality of primary particles is restored when unloaded, permanently deformed state of other particles of the plurality of primary particles is maintained. This dynamic property is caused by the effect of the micro-structure of the carbonaceous substance. The degree of elastic deformation and the degree of plastic deformation of the anode material member can be measured by an ultra-micro loading and unloading test described later.

When the thin-layer graphene substance is relatively thick, the portion of the thin-layer graphene substance maintains the elastic deformability within a certain stress range but is plastically deformed at once when the stress exceeds a predetermined threshold. In some cases with general carbon materials, deformation may occur due to a certain level of large stress, and the particles may be destroyed. That is, it can be said that the anode material member of the present embodiment has a nature of returning to its original shape with little deformation under a low stress such as the stress in the ultra-micro loading and unloading test, that is, a nature of a large elastic deformation workload.

The state in the micro-crystal structure of the thin-layer graphene substance can be analyzed by Raman spectrum measurement.

Characteristics of CMS and GMS will be described below.

CMS and GMS contain a plurality of primary particles having three-dimensional frame having internal spaces. Some of the plurality of primary particles are adhered to each other to form a secondary particle. The secondary particle has a nature of being plastically deformed and partially not restored in an ultra-micro loading and unloading test. In the present embodiment, the three-dimensional frame is made of a frame structure.

The carbonaceous substance forming CMS or GMS may include graphene. The plastic deformation power of CMS and GMS may be 5% or greater and 92% or less.

The pore volume of the carbon material of the present embodiment is, but is not particularly limited, preferably 0.1 cc/g or greater or also preferably any of 1 cc/g or greater, 1.5 cc/g or greater, 2 cc/g or greater, 2.95 cc/g or greater as a value measured by nitrogen adsorption/desorption measurement. The upper limit value thereof is, but is not limited to, any of 20 cc/g or less, 15 cc/g or less, 10 cc/g or less, 8 cc/g or less, 7 cc/g or less, 6.1 cc/g or less, or 5.7 cc/g or less. Further, it is preferable that the pore volume of CMS or GMS measured by a gas adsorption method be 1 cc/g or greater and 4 cc/g or less.

The index representing high-order structure of a frame structure having adjusted size or opening hole diameter of a three-dimensional nano-size space may be an oil absorption, a structural complexity, an interparticle void volume, or the like other than a pore volume.

The oil absorption value refers to the amount of oil absorbed in powder under a certain condition. Measurement of an oil absorption value (JIS K5101-13-1) may be measurement of an oil absorption that is one of the fundamental properties of carbon black used for rubbers. For example, carbon black is formed of an aggregated structure of primary particles. Micro-voids in the aggregated structures and voids between the aggregated structures have a capacity of absorbing oil, and such an amount of absorbing oil is used as a development index of an aggregated structure as “oil absorption”.

The CF of the present embodiment has an external space surrounded by an internal space or an outer wall. The entire space amount of such a space can be measured in accordance with the oil absorption (JIS K5101-13-1: Test methods for pigments—Part 13: Oil absorption—Section 1: Refined linseed oil method).

The lower limit of the oil absorption value of the CF of the present embodiment is 400 mL/100 g or greater, preferably 600 mL/100 g or greater, more preferably 800 mL/100 g or greater, further preferably 1000 mL/100 g or greater, and most preferably 1400 mL/100 g or greater.

The upper limit of the oil absorption value of the CF of the present embodiment is, but is not limited to, typically 5000 mL/100 g or less, preferably 4000 mL/100 g or less, more preferably 3500 mL/100 g or less, further preferably 3000 mL/100 g or less, and most preferably 2500 mL/100 g or less.

When the oil absorption value is in such a range, the CF has a large spatial volume and can be filled with more silicon generated from a silane gas, and this improves the capacity of the anode material.

In the conversion process from a gas to a solid, such as silane to silicon, the size of the space and affinity (wettability) with the frame structure in a change in forms are considered to be important for reaction field formation. More specifically, an organic-like silane gas transforms from organic component-like low-molecular weight polysilane to high-molecular-weight polysilane and then to solid silicon while being thermally decomposed. The inventors have found that the ratio between a pore volume, which is a measurement value of an amount of a gas diffused by a gas phase method and an oil absorption, which can be said as a measurement value of a permeable space into which a liquid organic substance is wet by a liquid phase method reflected by the organic component properties in such a transformation process is correlated with the performance of the final silicon-containing anode material.

The substantial index of silicon growth spatial structure (hereafter, referred to as an effective spatial index) during silane CVD is a value obtained by dividing the oil absorption value (mL/g) by a pore volume with nitrogen gas adsorption (mL/g, condition: P/P₀=0.99).

When the pore volume is in a range of 0.3 to 6.0 mL/g and the effective spatial index is in a range of 1.5 to 10.5, a CFSI anode material having a high capacity and high cycle performance can be realized. The range of the effective spatial index is preferably 1.6 to 8.0, more preferably 1.6 to 5.0, and most preferably 1.7 to 3.0.

The carbon layer stacking index of CMS or GMS found from Raman spectroscopy is 0.4 or greater and 5 or less. The carbon layer stacking index may be 0.5 or greater and 4.5 or less or may be 1 or greater and 4 or less.

Further, the bulk modulus K of CMS or GMS is preferably 2 GPa or less, and the average graphene network size L thereof is preferably 50 nm or greater. The average stacking number n of CMS or GMS may be 1 or greater and 6 or less, and the pore diameter d thereof may be 1 nm or greater and 65 nm or less. The BET specific surface area S of CMS or GMS is 400 m²/g or greater and 2600 m²/g or less.

The BET specific surface area of the carbon material of the present embodiment is, but is not particularly limited, preferably in a range of 100 to 2700 m²/g, 300 to 2500 m²/g, 500 to 2000 m²/g, 600 to 1800 m²/g, or 800 to 1200 m²/g as a specific surface area calculated from nitrogen adsorption defined by JIS Z8830. When the BET specific surface area of the carbon material of the present embodiment is in such a range, the conductivity and the oil absorption value are highly enhanced, which is preferable.

The edge site amount N_{edge} of CMS or GMS is preferably 500 μmol/g or less. The edge site specific surface area Sedge of CMS or GMS is 30 m²/g or less. The pore volume Vₜₒₜₐₗ of CMS or GMS may be 1.9 cm³/g or greater and 5 cm³/g or less.

A manufacturing method of the CF will be described. The manufacturing method of the CF according to the present embodiment includes steps of: arranging ceramic particles serving as a template; circulating organic hydrocarbon by CVD and coating a carbon layer or a graphene layer on the surface of the ceramic particles; and dissolving and eluting the ceramic particles, which are used as the template, with acid.

Typical ceramics are manufactured by formulating powder of a non-ferrous metal material to be used as a material, such as zirconia or alumina, in accordance with an intended product, molding the powder, and then sintering the molded powder. Ceramics are dense and hard and have high heat resistance, corrosion resistance, insulation properties, and the like and do not oxidize and rust. On the other hand, as ceramic particles serving as a template in the present embodiment, for example, ceramic particles formed of metal nanoparticles that can be dissolved with acid in a separation step are used.

In the separation step, when hydrofluoric acid is used, a template formed of nanoparticles of alumina, zeolite, or the like can be used. In the separation step, in terms of avoidance of use of hydrofluoric acid, it is preferable to use a template formed of metal nanoparticles formed of alkaline earth metal oxide. Specifically, a template formed of nanoparticles of magnesium oxide, calcium carbonate, calcium oxide, silicon dioxide, or the like can be used.

As the template ceramic particle, porous ceramics having internal nano-scale hole can be used. When avoiding the use of hydrofluoric acid in the separation step, the template ceramic particles is preferably formed of alkaline earth metal oxide and more preferably formed of magnesium oxide, calcium carbonate, or calcium oxide. Note that, when hydrofluoric acid is used in the separation step, ceramic particles formed of alumina, zeolite, or the like can be used.

The porous ceramics have a large number of pores (porous portions) therein and have high strength, rigidity, and heat resistance as with typical ceramics. Accordingly, since an internal space filled with a gas is created, porous ceramics are significantly light and have a smaller heat capacity and a lower thermal conductivity. It is possible to manufacture porous ceramics with flexible control of the size and shape of the pore, the texture shape, the rate of inclusion of pores per a certain area (porosity), or the like and thus enables the porous ceramics to have various functions.

Nano-scale spaces are present in the frame structure of the present embodiment. Such spaces can be manufactured by using template ceramic particles each having a nano-scale particle diameter.

The ceramic particles used in the present embodiment may include internal pores. The ceramic particles may include fine pores whose hole diameter is 100 nm or less. The hole diameter is preferably 100 nm or less, more preferably 1 nm or greater and 65 nm or less, and most preferably 2 nm or greater and 40 nm or less.

The CF of the present embodiment may have a pore, and such a pore may be a through hole or a bottomed hole. When silicon deposition is performed on the CF during production of the silicon anode material, silicon enters not only through holes but also bottomed holes and is deposited therein. The CF may include a fine pore with a hole diameter of 100 nm or less. The hole diameter is preferably 100 nm or less, more preferably 1 nm or greater and 65 nm or less, and most preferably 2 nm or greater and 40 nm or less.

With the structure having the CF having an internal space as a frame, it is possible to suppress structural destruction that would otherwise be caused by electron conduction or expansion and contraction due to charging and discharging during use of the lithium-ion battery.

The size and the opening hole diameter of the three-dimensional nano-size space in the frame structure can be adjusted via suitable selection of the size of the template ceramic particle or the internal pore structure as well as use of oxidation etching or impact fracture or the like.

By narrowing the space in the frame structure through the process using a physical stress as described above, it is possible to suppress the thickness of silicon to be deposited and thereby suppress expansion of silicon during charging and discharging. While any pressurizing method can be utilized to apply a physical stress, the particle strength varies in accordance with a factor such as the number of layers of graphene forming the frame.

In pressurizing particle powder, suitable selection of a pressurizing device, a retaining container, an applying element, or the like makes it possible to select conditions so that suitable pressurizing force is applied to the particle powder. In addition, a uniaxial powder compression system or a roll pressurization system can be applied. Further, hydraulic pressure, hydrostatic pressure, or the like can be utilized as a pressure source.

It is possible to change the pore diameter by a pore compression process using pressurization. For example, by pressurizing the CF whose peak diameter is 50 nm in the pore diameter distribution, it is possible to reduce the pore diameter to about 10 nm or less.

When the reduction in the total spatial amount is small while the pore diameter is reduced, the reduction in the anode capacity is also small. A smaller pore diameter enables a smaller thickness of deposited silicon and makes it possible to obtain a preferable cycle reversibility. While having the similar meaning to the pore diameter, the preferable thickness is 0.9 to 20 nm, more preferably 0.9 to 15 nm, and most preferably 1.0 to 10 nm.

The CF may be particulate, and the CF having a particular particle diameter, particle size distribution (particle diameter distribution), or shape may affect expansion during charging and discharging.

A powder CF has a particle size distribution. When producing an electrode by using an anode material with silicon being deposited on the CF, it is required to adjust the CF into a certain particle diameter in order to apply the CF as slurry with a binder or the like. The average particle diameter of the CF in such a case is preferably 1.3 μm to 50 μm, more preferably 1.5 μm to 30 μm, and most preferably 2 μm to 15 μm.

One of the indices of shapes is an aspect ratio. In typical anode materials, a smaller aspect ratio results in powder having higher flowability and improves ease of handling in the manufacturing process and the electrode filling property. Since the CF is made up of particles having various sizes and shapes, the aspect ratio is described using an average value. In a SEM observation image of CF particles, longer diameters and shorter diameters of 100 particles are measured, a value obtained by dividing a longer diameter by a shorter diameter is defined as the aspect ratio, and the average value of the total number of measurements is defined as the average aspect ratio. The average aspect ratio of CF particles is preferably 1 to 10, more preferably 1 to 7, and most preferably 1 to 5.

An average aspect ratio of the CF represents three-dimensional anisotropy of a particle and is a factor contributing to the anisotropy when silicon is alloyed with Li and expanded in the CFSI with silicon being deposited on the CF. The aspect ratio is a ratio between the longer diameter and the shorter diameter of a particle, a smaller aspect ratio of the CF causes more three-dimensionally uniform expansion in the electrode of CFSI particles with silicon being deposited, and higher anisotropy causes a larger expansion distance in the longer diameter direction. The optimal aspect ratio exists for some electrode design such as an additive amount of the CFSI into the electrode, a thickness of the electrode, or the like. In general, a smaller aspect ratio of the CF allows more isotropic expansion in the electrode of CFSI particles with silicon being deposited on the CF, and an impact of the expansion on the electrode is reduced, resulting in better characteristics.

A crushing and classification process can be performed for sorting in order to obtain the CF having a small aspect ratio. To industrially effectively manufacture the CF having a small aspect ratio, ceramic particles having a primary particle size of nm order size are granulated into 100 μm or less by granulation operation, and the process of making the CF is then applied. The granulation operation can be suitably operated with any commercially available dedicated device, and a scheme of using a rotary granulation device such as a media-type device using hard beads or the like, a scheme of adding a liquid to ceramic particles into slurry and changing the slurry into spherical powder by a method such as spray dry, or the like can also be employed.

While the granulated ceramic particle having an aspect ratio of 1.0, namely, being spherical is the most preferable, the shape thereof may be substantially spherical because ceramic particles may vary in their powder dimension or shape. When even a small amount of such particle powder having a small aspect ratio is contained in the CF, more preferable silicon-based anode material can be obtained.

A smaller ratio of the core frame structure relative to silicon causes a larger impact of expansion and contraction on structural destruction due to charging and discharging while the anode capacity is increased. At this time, the property of the lithium-ion battery is deteriorated. When a moderate ratio of the core frame structure relative to silicon is maintained, the reversibility of charging and discharging is improved. Thus, the ratio of CF relative to silicon can be suitably selected in accordance with the purpose.

### 3. Barrier Layer (BL)

Next, the barrier layer (hereafter, also referred to as “BL”) will be described. The silicon anode material having an internal CF (hereafter, also referred to as “CFSI anode material”) may have a barrier layer. The barrier layer is provided in order to suppress structural destruction due to a reaction film formation with an electrolyte solution or expansion and contraction. The barrier layer is provided on the outermost layer of the CFSI when the silicon deposition amount is increased in order to increase the capacity of the CFSI anode material. Thus, a certain degree of rigidity or a certain degree of flexibility is required for the BL. As the material of the BL, a carbonaceous substance, a graphene substance, or a thin-layer graphene substance is preferably used.

The BL of the present invention can be produced by applying a technique of a chemical vapor deposition method (hereafter, also referred to as “CVD method”). In the present embodiment, among CVD methods, a template chemical vapor deposition method (hereafter, referred to as “T-CVD method”) is preferable. This is a scheme of circulating an organic gas over a material having CVD activity and heated and coated in an inert gas atmosphere and mainly condensing carbon atoms of an organic substance in the gas to form a carbonaceous film.

To ensure CVD activity, catalytic active sites necessary for carbonaceous substance generation are formed on silicon surfaces by treatment with an oxide layer coating or a silane coupling agent.

### 4. Barrier Layer Void (BLV)

In the present embodiment, before providing the BL by CVD or the like as described above, it is possible to provide a layer void between the BL and the silicon surface layer by providing an oxide layer on the silicon surface, then generating the BL, and then removing the oxide layer by using a reagent. In the present specification, this is referred to as a barrier layer void (hereafter, also referred to as “BLV”). By providing such a BLV, it is possible to mitigate structural destruction due to charging and discharging.

The anode capacity and the expansion and contraction amount are determined by a silicon amount of the CFSI anode material, and by changing the amount of oxide layer in accordance therewith, the thickness (or volume) of the BLV can be adjusted. Accordingly, structural destruction can be mitigated, and charge and discharge reversibility can be improved.

As the reagent for removing contained oxides, acid or alkaline can be utilized. In the present embodiment, acid is preferably used, and hydrofluoric acid can be more preferably used.

The amount of the oxide layer is adjusted for adjusting the spatial volume of the BLV, and when the oxide layer is left, deterioration of the CSI anode material will be suppressed by the strength of the oxide layer in rapid charging and discharging, which is preferable.

When the contained oxide is layered, the thickness of the layer is preferably 1000 nm or less. The lower limit of the thickness of the layer is preferably 10 nm or greater, more preferably 30 nm or greater, and further preferably 50 nm or greater. The upper limit of the thickness of the layer is more preferably 800 nm or less and further preferably 500 nm or less.

### 5. Manufacturing Method of CFSI Anode Material

Next, the manufacturing method of the CFSI anode material will be described. In the present embodiment, the CFSI anode material containing the CF is manufactured by causing a compound having a silicon element to come into contact with the CF at a high temperature and depositing silicon on the CF by a vapor deposition reaction (CVD method).

The CF to be used can be subjected to a process of crushing and classification in advance and can be adjusted into a particle diameter that meets the intended use. The average value of particle diameters is preferably 1 to 70 μm and more preferably 2 to 30 μm.

Further, after the end of the final step, the processes of crushing and classification can be again applied to adjust the particle diameter in accordance with the intended use. The average value of particle diameters is preferably 1 to 70 μm and more preferably 2 to 30 μm.

Silane (SiH₄) is used as a compound having a silicon element, a gaseous silane may be diluted with an inert gas into a mixed gas, and CVD may be performed.

In the present embodiment, the CFSI anode material containing the CF is manufactured by depositing silicon on the CF by a CVD method of causing a compound having a silicon element to come into contact at a high temperature with the CF arranged in a reaction container. Silane (SiH₄) may be used as a compound having silicon, and a mixed gas with gaseous silane being diluted with an inert gas may be used to perform CVD.

Initially, the CF is arranged in the reaction container. Next, a compound containing silicon is circulated under a high temperature, and silicon is deposited on the surface of the CF by a CVD method. At this time, silicon is also deposited in the space formed inside the three-dimensional structure of the CF.

Gaseous silane can be mixed with another inert gas, for example, a nitrogen gas. The treatment temperature and time can be changed, and the treatment temperature can be, for example, 300 °C to 400 °C, 400 °C to 500 °C, 500 °C to 600 °C, 600 °C to 700 °C, 700 °C to 800 °C, or 800 °C to 900 °C. To manufacture an industrially stable material, 410 to 600 °C is preferable. The mixture of gases can include 0.1% by volume to 1% by volume of a silane gas and the remaining of an inert gas. Alternatively, the mixture of gases can include 1% by volume to 10% by volume of silane and the remaining of an inert gas, 10% by volume to 20% by volume of silane and the remaining of an inert gas, or 20% by volume to 50% by volume of silane and the remaining of an inert gas. Alternatively, the mixture of gases can include 50% by volume or more of silane and the remaining of an inert gas. The anode material characteristics such as a capacity or a cycle number can be stably exhibited. To manufacture an industrially stable CFSI anode material, the concentration of the silane gas in a CVD step is preferably 0.5 to 20% by volume.

As the reaction container in which the CVD method is performed, for example, a fluidized bed reactor, a fixed bed reactor, an elevator kiln, a rotary kiln, a box kiln, or other suitable reactor forms can be employed in accordance with various design known in the art. In a preferable embodiment, the CF is treated in a reaction container in which a gas is liquefied or in a reactor form in which a gas is stirred so that the CF is treated under conditions where the CF can be in uniform contact with the gas.

Further, after the CF is arranged, CVD may be performed after a mixed gas of silane diluted with an inert gas may be introduced in a reaction container vacuum-suctioned into a vacuum state. At this time, a suitable amount of the mixed gas can also be introduced in a pulse-like manner at intervals over a short period of time. In such a case, since silane is reliably filled in the nano-micro structure of the CF and then thermally decomposed, silicon can be deposited and filled at the highest density. This operation can be repeatedly performed in accordance with the purpose in order to obtain a high capacity or high reversibility.

Further, the manufacturing method of the lithium-ion battery anode material of the present embodiment may include, after the step of depositing silicon on the outer surface of the CF, steps of: providing an oxide layer on the outer surface of the deposited silicon; forming a barrier layer made of any of a carbonaceous substance, a graphene substance, and a thin-layer graphene substance on the outer surface of the oxide layer by a CVD method by using a hydrocarbon gas; and dissolving and eluting the oxide layer with acid to form a BLV between the barrier layer and the outer surface of the deposited silicon.

By adjusting the amount of the oxide layer on the silicon outer surface, it is possible to adjust the spatial volume of the BLV. When the oxide layer is left, destruction of the CFSI anode material is suppressed and degradation thereof is suppressed by the strength of the oxide layer in rapid charging and discharging. Further, the dissolving step can be omitted, and thus, the manufacturing cost can be reduced.

As described above, the manufacturing method of the anode material according to the present embodiment includes the step of arranging a product thermally dissolved from a source gas including carbon on the surface of the deposited silicon to form a barrier layer and then removing the oxide layer present between the deposited silicon and the barrier layer by acid treatment. Thus, the barrier layer obtained by the previous step and made of any of a carbonaceous substance, a graphene substance, and a thin-layer graphene substance and having a three-dimensional structure has plasticity while having a smaller thickness and thereby has some durability against expansion during lithium-silicon alloying. In the anode material according to the present embodiment, the BLV is provided between silicon and the BL. Accordingly, it is possible to suitably prevent collapsing and scattering of silicon particles that would otherwise be occur due to repetition of expansion/contraction and thus increase/decrease in volume of silicon caused by alloying and dealloying reactions.

### 6. Production of Barrier Layer and Barrier Layer Void

The lithium-ion battery anode material of the present embodiment may have a barrier layer (BL) on the deposited silicon. The predetermined temperature in the step of forming the barrier layer is in a range of 400 °C to 1200 °C. If the temperature is lower than 400 °C, carbon is less likely to be deposited on the surface. If the temperature is higher than 1200 °C, Si—C bind will be formed because of a reaction between silicon and carbon, and formation of an intended barrier layer will be prevented, which is not preferable.

The oxide layer on the silicon surface suppresses degradation of the CSI anode material by the strength of the oxide layer in case of rapid charging and discharging. Thus, a moderately high-strength layer such as oxide layers are preferable from the perspective of the degradation inhibition effect of anode materials. On the other hand, because the oxide layer is present on the surface of silicon, the amount of silicon that can be involved in the reaction is reduced. A reduction in the anode capacity can be utilized as long as the battery capacity is not substantially affected. The quantity of these high-strength layers should be small as much as possible. The quantity is preferably 50% by volume or less, more preferably 30% by volume or less, and further preferably 20% by volume or less relative to the volume of the entire CSFI.

In the barrier layer in the present step, in terms of controlling the number of layers to be formed into one or multiple layers, it is preferable to make use of chemical vapor deposition (CVD) method that is a dry method.

It is also possible to use a vacuum pulse CVD method of evacuating a reaction container into a vacuum state in which silicon covered with the oxide layer is arranged and causing a gas to flow for a particular time once or multiple times. Accordingly, the barrier layer is arranged on the oxide layer covering the surface of silicon.

Further, to facilitate a reaction of forming the barrier layer by the CVD method, a radical reaction mechanism made of an organic compound, hydrogen, water, a metal element, or the like may be utilized.

The pressure when the barrier layer formation step is performed by the CVD method can be, for example, 1 to 200 kPa. Further, the temperature rise rate in the barrier layer formation step is, for example, 1 to 50 °C/min. In arranging a product thermally decomposed from a source gas on the oxide layer of the silicon surface, performing gentle heating such as 1 to 50 °C/min causes crystallization to proceed at a moderate rate compared to a case of rapid heating at a larger temperature gradient, and it is possible to form a homogeneous carbon layer.

On the other hand, during formation of the barrier layer, when an organic substance having double bond or more is used as a carbon source, the organic substance is easily, thermally decomposed, and the bond broken at decomposition easily binds to another thermally decomposed product. Thus, the structure having disorder of the carbon six-membered ring structure is likely to be formed. With the use of such a bonding reaction, a barrier layer having a structural defect, that is, a through hole is formed.

In the barrier layer formation step, a gaseous organic molecule is used as a carbon source for carbon atoms forming the barrier layer. One or multiple types of gaseous organic molecules are selected from hydrocarbons such as methane, ethane, propane, butane, acetylene, ethylene, propylene, or butene or aromatic compounds such as benzene, toluene, naphthalene, or pyromellitic dianhydride. Preferably, the gaseous organic molecule is methane, acetylene, ethylene, or propylene.

In the barrier layer formation step, for example, an inert gas may be used as a carrier gas in addition to the source gas described above. Further, as the carrier gas, a gas including an oxygen gas, a hydrogen gas, or the like may be used other than an inert gas. In the barrier layer formation step, in terms of arranging one to two barrier layers, it is preferable to control the flow velocity of the carrier gas to be 0.05 to 1.00 m/min and control the amount of the source gas relative to the total amount of the source gas and the carrier gas to be 1 to 60% by volume.

The lithium-ion battery anode material of the present embodiment may have the barrier layer void (BLV) between the deposited silicon and the barrier layer. The BLV is generated by removing the oxide layer present between the silicon surface and the barrier layer by dissolving with acid. Herein, since a large number of fine holes are present in the barrier layer, a solvent for dissolving the oxide layer permeates the barrier layer. For the removal of the oxide layer, hydrofluoric acid (HF) is preferably used. Also in performing the present step, since carbon is a material that is resistant to hydrofluoric acid, which is a strong acid, the structure of the previously formed barrier layer is maintained during the present step. After the removal reaction by HF, a known washing method is applied, and thereby the substance derived from the dissolved oxide layer and HF are removed from the barrier layer and the silicon surface.

### 7. Anode and Battery Including CFSI Anode Material

Next, a lithium-ion rechargeable battery having the electrode containing the lithium-ion battery anode material of the present embodiment will be described.

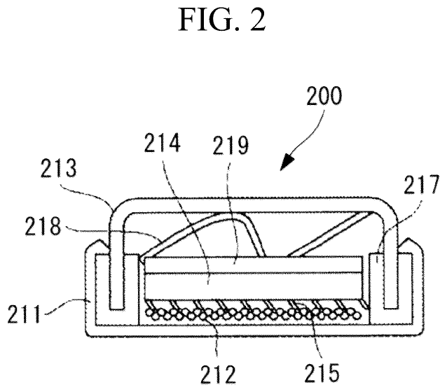

FIG. 2 illustrates an example of the sectional structure of a coin cell lithium-ion battery 200. The lithium-ion battery 200 has a disk-like cathode 212 accommodated in a metal exterior component 211 and a disk-like anode 214 accommodated in a metal exterior component 113 stacked together via a separator 215 therebetween. Note that a metal spring 218 and a spacer 219 are arranged between the exterior component 213 and the anode 214. The exterior component 211 and the exterior component 213 are filled with a liquid electrolyte, and peripheral edges of the exterior component 211 and the exterior component 213 are sealed by being caulked via a sealing gasket 217.

Next, the anode will be described. For example, slurry in which a carbon-based material, which is the primary active material, a binder, and a solvent are mixed is coated on the current collecting metal foil such as a rolled copper foil, the solvent is removed by heating and drying, the remaining is then formed into a predetermined dimension and density, and thereby the anode 214 is obtained.

The anode material of the present embodiment is preferably used by mixing the primary active materials. With the use of a powder-like material as the carbon-based material described above, it is possible to easily mix the material with the binder and the solvent.

As the carbon-based materials that can be used for the anode, a material that can bind and stabilize Li ions with electrons flowing in from an external circuit and has a large number of stabilizing sites inside is preferred.

For example, any material originating from an organic substance with high or low crystallinity can be used, and graphite, coke, amorphous carbon, hard carbon, polymer carbon, or the like can be suitably used. In such a case, the principle is that Li ions are held between graphene layers or the like, bound with electrons in this state, and stabilized.

Further, as another stabilizing mechanism, a method of electrochemically forming an intermetallic compound can also be used, and silicon, tin, zinc, bismuth, antimony, cadmium, lead, germanium, or the like can be suitably used.

In addition, other materials exhibiting low electrochemical reaction potentials can also be used to serve as the anode side of the lithium-ion battery. Preferably, the materials may be compounds of metals and oxygen, sulfur, halogen, nitrogen, phosphorus, or the like.

Further, to obtain a particular discharge profile for some applications of the lithium-ion battery, a plurality of anode materials described above can be mixed at a predetermined ratio, and the mixture can be used.

The physical properties of the anode material are determined from requirement items for design of a device (a storage battery as an example) and manufacturing process due to constraint conditions such as a usage form of the lithium-ion battery. In manufacturing of the materials thereof, process design or the like have been made to be able to achieve desired physical properties thereof. Physical property values of generally used anode materials may be powder particle diameter and distribution, a specific surface area, a density, and the like of the anode material.

As an example, the powder particle diameter of generally used anode materials is suitably selected taking other configuration requirements of a lithium-ion battery into consideration. In terms of improvement in the battery characteristics such as rate characteristics, cycle characteristics, or the like, the powder particle diameter of general anode materials is preferably 1 to 70 μm and more preferably 2 to 30 μm in average. The CFSI anode material of the present embodiment is also made of powder particles, and the average particle size (average particle diameter) is preferably 2 μm or greater and 20 μm or less, more preferably 3 μm or greater and 18 μm or less, and further preferably 4 μm or greater and 10 μm or less.

Although the anode materials described above have generally high electron conductivity, some materials have smooth surfaces, and when contact between particles is insufficient, it is also preferable that a conductive agent for assisting the electron conductivity coexist. As a material thereof, carbon-based materials and metal-based materials as well as other materials having high electron conductivity can be used, and the carbon-based materials are suitable among these materials. The frame structure of the present embodiment described above may be used as a conductive agent.

The amount of the conductive agent to coexist has to be the minimum necessary, and the content of the anode material that defines the capacity of the lithium-ion battery has to be increased to the maximum.

Conventional carbon-based materials may be soot, acetylene black, Ketjen black, lamp black, furnace black, carbon black, graphite, carbon fiber, graphite fiber, nanofiber, nanotube, coke, hard carbon, amorphous carbon, or the like.

Compared to the above, CMS, GMS, or the like functioning as a frame structure have significant features that are not achieved by the conventional material. Furthermore, if necessary, a further efficacy can be obtained in combined use with the conventional material. For example, thin strip-like graphite, carbon nanotubes with high linearity, or the like have high electron conductivity but have a low ion storage ability. Thus, the combination with the anode material member of the present invention makes it possible to construct a good battery reaction assisting system in which ion storage ability is added to electron conductivity.

Further, carbon blacks such as acetylene black are formed of connected structural particles having a diameter of several tens of nanometers. On the other hand, the carbon blacks are not suitable for long distance transfer of electrons, because the carbon blacks have not very high crystallinity of carbon, also have a short structural length, and easily collapse. Although having such natures, the carbon blacks in combination with the assisting material of the present invention can realize a system that maintains electron conductivity and also has an ion supply ability even when the steric structure is maintained, when the steric structure is collapsed and flattened as with flake graphite, or the like.

The ratio suitable for containing the CF as the conductive agent in the anode varies in accordance with a difference in a type of the anode material, a type and an amount of a binder, battery capacity design, or the like. In the present embodiment, as described above, the addition rate of the frame structure to the anode is preferably greater than or equal to 0.1% by weight and less than or equal to 5% by weight per electrode mixture. With the addition in such a range, good characteristics can be obtained.

As the current collecting metal foil, materials that are inexpensively available and durable for industrial use are preferred, and materials not having electrochemically reactivity to a potential developed by the anode are suitably used. As an example of the current collecting metal foil, copper foils, nickel foils, titanium foils, and stainless-steel foils are preferred, and electrolytic copper foils and rolled copper foils that are easily available in general are more preferred.

As a method of forming the film coated with slurry described above, commonly used printing techniques can be used. When the thickness dimension is small, printing methods such as gravure printing are suitably used, and when the thickness dimension is large, printing methods such as doctor blade printing or die printing are suitably used.

The coated film is then heated and dried. Any drying method can be used, and methods that can achieve a desired binding strength in accordance with a binder are suitably used.

Further, when the anode is then formed into a predetermined dimension, an industrially available cutting blade or the like and the system thereof are suitably used. Further, to achieve a predetermined density, an industrially available pressurizing device or the like and the system thereof are suitably used if necessary.

The anode material and the conductive agent described above are often in a powder form, and to fix particles of the powder to each other and onto the current collecting metal foil, it is preferable to mix a small amount of binder for use. The binder is required to be chemically and electrochemically inactive and have some elastic deformability and affinity, and plastic resin materials are suitably used.

As another usage form of the frame structure, it can be used in a state of a paint in which powder is dispersed in a liquid solvent at a constant ratio. In such a case, for the solvent, organic or inorganic compounds applicable to manufacturing of lithium-ion batteries can be used. To maintain a good dispersion state of the powder in the solvent, an organic or inorganic dispersion agent (as an example, a monomolecular or plastic resin material) can be suitably used.

The plastic resin material described above may be, for example, fluorine-based resin such as polyvinyl fluoride, polyvinylidene fluoride, and polytetrafluoroethylene, CN group-containing polymers such as polyacrylonitrile and polyvinylidene cyanide, polyvinyl alcohol-based polymers such as polyvinyl acetate and polyvinyl alcohol, halogen containing polymers such as polyvinyl chloride and polyvinylidene chloride, conductive polymers such as polyaniline, alkane-based polymers such as polyethylene, polypropylene, and poly-1,1-dimethylethylene, unsaturated polymers such as polybutadiene and polyisoprene, polymers with rings such as polystyrene, polymethylstyrene, polyvinylpyridine, and poly-N-vinylpyrrolidone, acrylic polymers such as polymethyl methacrylate, polyethyl methacrylate, polybutyl methacrylate, polymethyl acrylate, polyethyl acrylate, polyacrylic acid, polymethacrylic acid, polyacrylamide, carboxymethyl cellulose, styrene butadiene rubber, or the like. Further, the plastic resin material may be mixtures, modified products, derivatives, random copolymers, alternating copolymers, graft copolymers, block copolymers, or the like of the resin materials described above. The weight-average molecular weight of these resins is typically 10,000 to 3,000,000, preferably 100,000 to 1,000,000. An excessively small molecular weight reduces the strength of the coated film, and an excessively large molecular weight increases the viscosity and makes it difficult to form the electrode.

To sufficiently uniformly distribute the binder and to form the slurry to be a coated film having a predetermined dimension, a suitable slurry solvent that dissolves only the binder resin and does not dissolve other materials can be used. For example, when polyvinylidene fluoride is used, dimethylformamide is suitably used as the solvent. Alternatively, N-methylpyrrolidone may be used as the solvent, and can be selected as appropriate in accordance with the conditions of the manufacturing process.

The cathode will be described.

In general, the cathode 212 is obtained by applying slurry made of a mixture of a metal oxide-based material, a conductive agent for assisting electron conductivity, a binder, and a solvent onto a current collecting metal foil such as a rolled aluminum foil, thereby forming a coated film, heating and drying the coated film to remove the solvent, and then forming the coated film into predetermined dimension and density.

A metal compound-based material that can be used for a cathode active material is a material that can release electrons to an external circuit of the battery and release Li ions to an electrolyte at the same time. While the amount of contained Li ions varies in accordance with the chemical composition, crystal structure, or the like thereof, it is preferable to use a material that can reversibly take in and out a large amount of Li ions.

Examples of the material may be transition metal oxides, composite oxides of lithium and transition metals, transition metal sulfides, or the like. As the transition metal, Fe, Co, Ni, Mn, or the like are used. Specific examples may be transition metal oxides such as MnO, V₂O₅, V₆O₁₃, and inorganic compounds such as TiO₂, LiNiO₂, LiCoO₂, LiMn₂O₄, and TiS₂, FeS, and MoS₂. To improve their characteristics, transition metal oxides in which a particular element thereof is partially substituted with a certain element may be used.

In addition to the inorganic compounds described above, cathode materials made of organic compounds can be also used. For example, polyaniline, polypyrrole, polyacene, disulfide-based compounds, polysulfide-based compounds, N-fluoropyridinium salts, or the like may be used. The cathode materials may be a mixture of the inorganic compounds and the organic compounds described above.

The physical properties of the cathode material are determined from requirement items for battery design and manufacturing process due to constraint conditions such as a usage form of the lithium-ion battery. In manufacturing of the cathode material, process design or the like have been made to be able to achieve desired physical properties thereof. Examples of physical property values may be powder particle diameter and distribution, a specific surface area, a density, or the like.

As an example, the powder particle diameter is selected as appropriate under consideration on other composition requirements of the lithium-ion battery, and is typically, preferably 1 to 30 μm, more preferably 1 to 10 μm as an average value in terms of improvement in battery characteristics such as rate characteristics or cycle characteristics.

Since the cathode materials described above have generally low electron conductivity, it is preferable that a the battery reaction assisting material for assisting the electron conductivity coexist within the cathode. As a material of the generally used conductive agent, carbon-based materials and metal-based materials as well as other materials having high electron conductivity can be used, and the carbon-based materials are suitable among these materials. The frame structure of the present embodiment may be used as the battery reaction assisting material.

The amount of the battery reaction assisting material to coexist has to be the minimum necessary, and the content of the cathode material that defines the capacity of the lithium-ion battery has to be increased to the maximum.

Conventional carbon-based materials may be soot, acetylene black, Ketjen black, lamp black, furnace black, carbon black, graphite, carbon fiber, graphite fiber, nanofiber, nanotube, coke, hard carbon, amorphous carbon, or the like.

Compared to the above, when used as a battery reaction assisting material, the frame structure of the embodiment has significant features that are not present in the conventional material. Since the frame structure of the present embodiment contains a relatively large area of graphene in the structure, there are few defects other than carbon-carbon bonds, such as oxygen-containing functional groups at the ends of six-membered ring carbon bonds. Therefore, the frame structure is less likely to deteriorate or decompose in the electrochemical oxidation environment inside in the battery.

Further, if necessary, a further efficacy can be obtained in combined use with the conventional material described above. For example, thin strip-like graphite, highly linear carbon nanotubes, or the like have high electron conductivity but have a low ion storage ability. The combination of the above material having such a nature with the frame structure of the present embodiment makes it possible to construct a suitable battery reaction assisting system in which ion storage ability is added to electron conductivity.

Further, carbon blacks such as acetylene black are formed of connected structural particles having a diameter of several tens of nanometers. On the other hand, the carbon blacks are not suitable for long distance transfer of electrons, because the carbon blacks have not very high crystallinity of carbon, also have a short structural length, and easily collapse. Combination of the carbon blacks with the frame structure described above can realize a system that maintains electron conductivity and also has an ion supply ability even when the steric structure is maintained or when the steric structure is collapsed and flattened as with flake graphite.

The ratio suitable for containing the frame structure made of the carbon material in the cathode varies in accordance with a difference in a type of the cathode material, a type and an amount of a binder, battery capacity design, or the like. In the present embodiment, as described above, the addition rate of the battery reaction assisting material to the cathode is preferably greater than or equal to 0.1% by weight and less than or equal to 5% by weight per electrode mixture. With the addition in such a range, suitable properties can be obtained.

The cathode material and the frame structure described above are often in a powder form, and to fix particles of the powder to each other and onto the current collecting metal foil, it is preferable to mix a small amount of a binder. The binder is required to be chemically and electrochemically inactive and have some elastic deformability and affinity, and plastic resin materials are suitably used.

As another usage form of the battery reaction assisting material, it can be used in a state of a paint in which powder is dispersed in a liquid solvent at a constant ratio. In such a case, for the solvent, organic or inorganic compounds applicable to manufacturing of lithium-ion batteries can be used. To maintain a good dispersion state of the powder in the solvent, an organic or inorganic dispersion agent (as an example, a monomolecular or plastic resin material) can be suitably used.

The plastic resin material described above may be, for example, fluorine-based resin such as polyvinyl fluoride, polyvinylidene fluoride, and polytetrafluoroethylene, CN group-containing polymers such as polyacrylonitrile and polyvinylidene cyanide, polyvinyl alcohol-based polymers such as polyvinyl acetate and polyvinyl alcohol, halogen containing polymers such as polyvinyl chloride and polyvinylidene chloride, conductive polymers such as polyaniline, alkane-based polymers such as polyethylene, polypropylene, and poly-1,1-dimethylethylene, unsaturated polymers such as polybutadiene and polyisoprene, polymers with rings such as polystyrene, polymethylstyrene, polyvinylpyridine, and poly-N-vinylpyrrolidone, acrylic polymers such as polymethyl methacrylate, polyethyl methacrylate, polybutyl methacrylate, polymethyl acrylate, polyethyl acrylate, polyacrylic acid, polymethacrylic acid, and polyacrylamide. Further, the plastic resin material may be mixtures, modified products, derivatives, random copolymers, alternating copolymers, graft copolymers, block copolymers, or the like of the resin materials described above. The weight-average molecular weight of these resins is typically 10,000 to 3,000,000, and preferably 100,000 to 1,000,000. An excessively small molecular weight reduces the strength of the coated film, and an excessively large molecular weight increases the viscosity and makes it difficult to form the electrode.

To sufficiently uniformly distribute the binder and to form the slurry to be a coated film having a predetermined dimension, a suitable slurry solvent that dissolves only the binder resin and does not dissolve other materials can be used. For example, when polyvinylidene fluoride is used, dimethylformamide is suitably used as the solvent. Alternatively, N-methylpyrrolidone may be used as the solvent, and can be selected as appropriate in accordance with the conditions of the manufacturing process.

As the current collecting metal foil, materials that are inexpensively available and durable for industrial use are preferred, and materials having electrochemically resistance to a potential developed by the cathode are suitably used. As an example of the current collecting metal foil, aluminum foils, nickel foils, titanium foils, and stainless-steel foils are preferred, and rolled aluminum foils that are easily available in general are more preferred.

As a method of forming the film coated with slurry to a current collecting metal foil, commonly used printing techniques can be used. When the thickness dimension of the coated film is small, printing methods such as gravure printing are suitably used, and when the thickness dimension of the coated film is large, printing methods such as doctor blade printing or die printing are suitably used.

The coated film is then heated and dried. Any drying method can be used, and methods that can achieve a desired binding strength in accordance with a binder are suitably used.

Further, when the cathode is then formed into a predetermined dimension, an industrially available cutting blade or the like and the system thereof are suitably used. Further, to achieve a predetermined density, an industrially available pressurizing device or the like and the system thereof are suitably used if necessary.

The electrolyte for the battery applied to the lithium-ion battery will be described.

The electrolyte is obtained by dissolving a solute in an organic solvent, and typically, the solute and the organic solvent are the main components.

One of the compositions of the electrolyte is primarily a solute that is a source of ions, that is, a Li salt.

The type of the solute is not particularly limited, and any solute can be used as long as it is known to be utilized for the application of such a lithium-ion battery. Specifically, the following can be used.

Examples of the solute may be inorganic salt such as LiPF₆ and LiBF₄, fluorine-containing organic Li salt such as LiCF₃SO₃, LiN(CF₃SO₂)₂, LiN(C₂F₅SO₂)₂, Li cyclic 1,2-perfluoroethane disulfonylimide, Li cyclic 1,3-perfluoropropane disulfonylimide, LiN(CF₃SO₂)(C₄F₉SO₂), LiC(CF₃SO₂)₃, LiPF₄(CF₃)₂, LiPF₄(C₂F₅)₂, LiPF₄(CF₃SO₂)₂, LiPF₄(C₂F₅SO₂)₂, LiBF₂(CF₃)₂, LiBF₂(C₂F₅)₂, LiBF₂(CF₃SO₂)₂, and LiBF₂(C₂F₅SO₂)₂, Li bis(oxalate) borate, or the like.

Among the above, LiPF₆, LiBF₄, LiN(CF₃SO₂)₂, and LiN(C₂F₅SO₂)₂ are preferred in terms of exerting battery performance, and LiPF₆ and LiBF₄ are particularly preferred.

Note that these Li salts may be used alone, or two or more of these Li salts may be used in combination.

The content ratio of Li salt in the electrolyte will vary in accordance with the type of the solvent used to dissolve the Li salt or the mixture composition thereof. The content ratio of Li salt in the electrolyte is preferably 7 to 190% by weight, more preferably 10 to 180% by weight, still more preferably 13 to 150% by weight.

Next, organic solvents used for the electrolyte will be described.

The type of the organic solvent is not particularly limited, and the organic solvent can be selected as appropriate from those conventionally known as solvents. For example, cyclic carbonates, chain carbonates, cyclic ethers, chain ethers, cyclic carboxylic acid esters, chain carboxylic acid esters, phosphorus-containing organic solvents, or the like having no unsaturated bond may be used.

Factors that affect the migration of Li ions may be the viscosity and the solvation ability of the organic solvent in addition to viscosity. The solvation ability is the force to dissociate dissolved ions, and since an excessively strong solvation ability inhibits the migration of ions, there is an optimum value.

Further, the operating environment conditions for practical lithium-ion batteries are of a wide range, and in particular, the physical properties of the organic solvent, such as the melting point or the boiling point, are also required to be included within a certain range.

A practical solution to the above requirements is to use a mixture of multiple organic solvents. The mixture composition thereof is determined by taking practical characteristics into consideration from combinations of physical properties such as the organic solvent having a high melting point, the organic solvent having a low melting point, the organic solvent having a high solvation ability, the organic solvent having a low solvation ability, or the like.

In the electrolyte, it is preferable to mix cyclic carbonates and chain carbonates, both of which do not have carbon-carbon unsaturated bonds.

The cyclic carbonate may be alkylene carbonates having an alkylene group having 2 to 4 carbon atoms, such as ethylene carbonate, propylene carbonate, or butylene carbonate. Among these cyclic carbonates, ethylene carbonate and propylene carbonate are preferred in terms of improvement in battery characteristics, and ethylene carbonate is particularly preferred.

As the chain carbonates, dialkyl carbonate is preferred, and the number of carbon atoms in the constituent alkyl groups is preferably 1 to 5, particularly preferably 1 to 4. Specifically, for example, dialkyl carbonate such as symmetrical chain alkyl carbonates such as dimethyl carbonate, diethyl carbonate, or di-n-propyl carbonate; or asymmetric chain alkyl carbonates such as ethylmethyl carbonate, methyl-n-propyl carbonate, or ethyl-n-propyl carbonate may be used. Among these chain carbonates, dimethyl carbonate is preferred because the viscosity thereof is the lowest.

However, since dimethyl carbonate has a slightly lower boiling point, more suitable characteristics can be obtained by further mixing chain carbonates having a higher boiling point. Although diethyl carbonate is preferred for the chain carbonate to be mixed, other chain carbonates can also be used without any problems.

The mixing ratio also varies in accordance with desired practical characteristics. There is an optimum composition for the ratio of chain carbonate to cyclic carbonate, including the ratio of Li salt.

The content ratio of cyclic carbonate in the electrolyte is preferably 1 to 35% by weight, more preferably 3 to 30% by weight, still more preferably 4 to 25% by weight. A plurality of cyclic carbonates can be mixed.

On the other hand, the content ratio of chain carbonate in the electrolyte is preferably 40 to 70% by weight, more preferably 43 to 68% by weight. A plurality of chain carbonates can be mixed.

The following combinations are suitable as the overall composition.

Among combinations of ethylene carbonate and dialkyl carbonates, ethylene carbonate and dimethyl carbonate are preferred, and may further contain a symmetric chain dialkyl carbonate and/or an asymmetric chain dialkyl carbonates. For example, the combination containing ethylene carbonate, symmetrical chain dialkyl carbonates, and asymmetric chain dialkyl carbonates such as ethylene carbonate, dimethyl carbonate and diethyl carbonate, ethylene carbonate, dimethyl carbonate and ethyl methyl carbonate, ethylene carbonate, dimethyl carbonate, diethyl carbonate, and ethyl methyl carbonate is preferred because of a good balance between cycle characteristics and high-output discharge characteristics. Among the above, the asymmetric chain dialkyl carbonate is preferably ethyl methyl carbonates, and further, the alkyl group of the alkyl carbonate preferably having 1 to 2 carbon atoms is preferred.

Furthermore, as the solvent that aids in dissociation or migration of ions or the like, cyclic ethers, chain ethers, cyclic carboxylic acid esters, chain carboxylic acid esters, or the like can be added in association with the main organic solvents listed above.

The cyclic ethers may be tetrahydrofuran, 2-methyltetrahydrofuran, or the like, and the chain ethers may be dimethoxyethane, dimethoxymethane, or the like.

The cyclic carboxylic acid esters may be γ-butyrolactone, γ-valerolactone, or the like, and the chain carboxylic acid esters may be, methyl acetate, methyl propionate, ethyl propionate, methyl butyrate, or the like.

Among the above, the chain carboxylic acid esters are particularly suitable.

Furthermore, it is preferable to contain fluorine-containing cyclic carbonate having two or more fluorine atoms in the electrolyte.

Although the number of fluorine atoms in fluorine-containing cyclic carbonate having two or more fluorine atoms is not particularly limited in the case of fluorinated ethylene carbonate, the lower limit number is typically two or greater, and the upper limit number is typically four or less, preferably three or less.

In the case of fluorinated propylene carbonate, the lower limit number is typically two or greater, and the upper limit number is typically six or less, preferably five or less. In particular, the fluorinated propylene carbonate having two or more fluorine atoms bound to the carbon atoms forming the ring structure is preferred in terms of improvement in cycle characteristics and storage characteristics.

Among the above, fluorinated ethylene carbonate having two or more fluorine atoms is preferred in terms of improvement in battery characteristics, and furthermore, among the above, cis-4,5-difluoro-1,3-dioxolan-2-one, trans-4,5-difluoro-1,3-dioxolan-2-one or 4,4-difluoro-1,3-dioxolan-2-one is particularly preferred.

The fluorine-containing cyclic carbonate having two or more fluorine atoms may be used alone, or two or more types of the fluorine-containing cyclic carbonates may be used in combination. The ratio of the fluorine-containing cyclic carbonate compound having two or more fluorine atoms in the non-aqueous electrolyte solution is not particularly limited in achieving the effect of the present embodiment, and is typically 0.001% by weight or higher, preferably 0.01% by weight or higher, more preferably 0.1% by weight or higher, particularly preferably 0.2% by weight or higher, most preferably 0.25% by weight or higher. At a concentration lower than the above, it may be difficult to achieve the effect of the present embodiment. On the contrary, since an excessively high concentration may increase the internal pressure of the battery during high-temperature storage, the upper limit is typically 10% by weight or less, preferably 4% by weight or less, more preferably 2% by weight or less, particularly preferably 1% by weight or less, most preferably 0.5% by weight or less.

In addition, cyclic carbonates having unsaturated bonds or aromatic compounds having a total carbon number of 7 or greater and 18 or less may be mixed in the electrolyte.

Among the cyclic carbonates having an unsaturated bond, vinylene carbonate, vinylethylene carbonate, 4-methyl-4-vinylethylene carbonate, or 4,5-divinylethylene carbonate is preferred in terms of improvement in cycle characteristics, and among these cyclic carbonates, vinylene carbonate or vinylethylene carbonate is more preferred. These cyclic carbonates may be used alone, or two or more types of these cyclic carbonates may be used in combination.

As the aromatic compound having a total carbon number of 7 or greater and 18 or less, aromatic compounds such as biphenyl, alkylbiphenyl, terphenyl, partially hydrogenated terphenyl, cyclohexylbenzene, t-butylbenzene, t-amylbenzene, diphenyl ether, dibenzofuran, or the like are preferred.

When side reactions between the aromatic compound having a total carbon number of 7 or greater and 18 or less and the anode and cathode are suppressed in such a way, it is expected that the significant deterioration of discharge characteristics after high-temperature storage can be suppressed.

To achieve the effect of the present embodiment, the ratio of aromatic compound having a total carbon number of 7 or greater and 18 or less in the electrolyte is typically 0.001% by weight or higher, preferably 0.1% by weight or higher, particularly preferably 0.3% by weight or higher, most preferably 0.5% by weight or higher, the upper limit is typically 5% by weight or less, preferably 3% by weight or less, particularly preferably 2% by weight or less. At a concentration lower than this lower limit, it may be difficult to achieve the effect of improving safety during overcharging. On the contrary, an excessively high concentration may reduce the battery characteristics such as high-temperature storage characteristics.

The separator 215 separates the cathode 212 and the anode 214 from each other and allows lithium ions to pass through while preventing a short circuit of current due to contact between the two electrodes, and a porous membrane made of resin is suitably used.

As a membrane form, a stretched membrane in which pores are formed by stretching bulk resin, a nonwoven fabric in which a pore structure like a porous membrane can be created by laminating a large number of fiber-like resin fibers, or the like are suitably used.

The material for the resin may be polyolefins, and polyethylene is particularly suitable. Polyethylene has a relatively low melting temperature, and when the temperature of the battery rises for some reason (an unsafe condition such as a short circuit or the like as an example), the pores in the membrane are closed due to heat fusion, the migration of driving ions is inhibited, thereby the reaction is stopped, and safety can be ensured.

In porous membranes formed by the stretching scheme, typically, a plasticizer or the like are added to polyolefin, the plasticizer is removed before or after the stretching, and the porous membranes have a relatively uniform microporous structure from a portion as a starting point where the plasticizer has been present or the like.

In manufacturing of a stretched membrane, stretching is typically performed in both the longitudinal direction and the width direction. A suitable stretched membrane can be obtained by combining any atmospheric medium, a temperature, a speed, a stress, the number of process repetitions, or the like as appropriate, in addition to the removal of the plasticizer or the like as described above.

Although a high-quality stretched membrane can be obtained through the above manufacturing step, multiple phases of steps are required. This makes it difficult to reduce manufacturing costs such as processing costs, and this may be a negative factor in the spread of lithium-ion batteries.

In contrast, by simplifying steps so that stretching is performed only in the longitudinal direction without using a plasticizer or the like, it is possible to obtain a porous membrane that can be manufactured on an industrial scale and also reduce the manufacturing costs. In such a case, the applicable resin is polyolefin, and polypropylene is suitable used.

The separator interposed between the cathode and the anode can be any separator as long as it is formed of an electrically insulating porous body. As the separator, for example, a membrane or a fibrous nonwoven fabric made of polymer such as a polyolefin such as polyethylene and polypropylene, polyester, polyethylene terephthalate, or polyimide is applicable. As the material of the separator, a single type thereof may be used alone, or multiple types thereof may be used. Further, the separator may be of a single layer or a multilayer (composite membrane). Further, the separator may contain nanoparticles of an inorganic material such as ceramic. Further, a high molecular compound such as polyvinylidene fluoride may be applied to both sides of the separator.

In the non-aqueous electrolyte battery, an electrolyte in a gel form made by containing a polymer compound that becomes a holder that swells with an organic solvent and retains the non-aqueous electrolyte may be used. This is because, when a polymer compound that swells with an organic solvent is contained, high ionic conductivity can be obtained, excellent charge/discharge efficiency can be obtained, and leakage of the battery can be prevented. When the non-aqueous electrolyte contains a polymer compound, the content of the polymer compound is preferably within a range of 0.1% by weight or greater and 10% by weight or less of the non-aqueous electrolyte.

Further, when a polymer compound such as polyvinylidene fluoride is applied to both sides of the separator, the mass ratio of the non-aqueous electrolyte to the polymer compound is preferably within a range of 50:1 to 10:1. With the mass ratio being within this range, higher charge/discharge efficiency can be obtained.

The above polymer compound may be, for example, ether-based polymer compounds such as polyvinyl formal, polyethylene oxide, and crosslinked products containing polyethylene oxide, ester-based polymer compounds such as polymethacrylate, acrylate-based polymer compounds, and polyvinylidene fluoride, and polymers of vinylidene fluoride such as copolymers of vinylidene fluoride and hexafluoropropylene. A single type of polymer compound may be used alone, or multiple types thereof may be used as a mixture. In particular, in terms of the effect of preventing swelling during high-temperature storage, it is desirable to use a fluorine-based polymer compound such as polyvinylidene fluoride.

The lithium-ion battery having the configuration as described above operates as follows.

When the lithium-ion battery is charged, Li ions contained in the cathode 212 pass through the separator 215 and are inserted between layers of the layered structure of graphite contained in the anode 214. Then, when the energy storage device is discharged, Li ions are released from between the layers the layered structure included in the anode 214, pass through the separator 215, and return to the cathode 212. With a series of these operations, the battery reaction proceeds.

Although one embodiment of the present invention has been described in detail above, the present invention is not limited to the above embodiment, and various modifications and changes are possible within the scope not departing from the spirit of the present invention recited in the claims.

Although the coin cell lithium-ion battery has been described as the lithium-ion battery as an example in the above embodiment, the lithium-ion battery of the present embodiment can be similarly applied to batteries having other shapes such as a button type, a paper type, a rectangular type, or a cylindrical type with spiral structure. Further, the lithium-ion battery of the present embodiment can have various sizes such as a thin device or a large device.

Furthermore, although the embodiment assuming the case of the lithium-ion battery having a liquid electrolyte as the electrolyte used for the lithium-ion battery according to the present embodiment has been expressed in the above description, any other electrolytes can be applicable. To give some examples, gel electrolytes or solid electrolytes can also be suitably used.

### 8. Battery Reaction

The anode reaction in the anode with the anode material according to the present embodiment is such that electrons transferred from an external circuit reach a silicon particle surface, Li ions and electrons are bound to form an Li—Si reaction phase, and an alloyed composition is produced. The produced Li—Si reaction phase spreads into particles, and the production of the Li—Si reaction phase proceeds until the combination limit is reached, that is, before the Li-metal deposition potential is reached. The crystal lattice is expanded due to the Li—Si alloying reaction, causing volumetric expansion of silicon particles, whereby the battery brought into a charged state. Contrarily, after release of Li, volumetric contraction of silicon particles occurs, and the battery is brought into a discharged state.

In the initial phase in which the Li—Si reaction phase is formed in the alloying reaction, an inactive reaction product made of an electrolyte solution component, Li, or the like is deposited on the surface of silicon particles, and thereby a film is formed. The surface state of silicon particles changes due to a volumetric change of the silicon particles caused by repetition of charging and discharging, and thereby a new reaction interface not covered with the inactive reaction product is repeatedly exposed.

When an inactive reaction product is newly deposited on the exposed reaction interface by a side reaction and Li ions are consumed by the side reaction, the reversible Li capacity of the battery decreases. Such a decrease leads to a reduction in the battery capacity.

### EXAMPLES

### [Experiment 1: Manufacturing of Different Types of Frame Structure]

### Example 1

As a template ceramic particle having fine pores, magnesium oxide nano-powder (primary particle size: 0.5 μm, specific surface area (SSA): 120 m²/g, peak pore diameter: 7 nm, by Kyowa Chemical Industry Co., Ltd.) was filled in a heat treatment container, and this heat treatment container is loaded in a tube-type reaction container. The inside of the reaction container is replaced with an argon gas, and the temperature thereof was then raised to 910 °C. If necessary, pre-heat treatment is added for the purpose of dehydration or the like. A mixed gas of an argon gas and a CH₄ gas (the concentration of the CH₄ gas was 20% by volume) was then allowed to flow for 120 minutes, and a carbonaceous film including the graphene structure was formed on the template by a T-CVD method. After cooling, the template ceramic particles forming the carbonaceous film are taken out and subjected to a crushing and classification process.

Next, the product resulted from the crushing and classification process was treated with hydrochloric acid to elute the template, the template was washed and dried while the intraparticle space was retained, and a CF precursor (frame structure precursor) was obtained. This was subjected to carbon structure optimization through heat treatment at 1600 °C in an inert atmosphere, and the CF of Example 1 was obtained.

Particle size distribution measurement was performed on the obtained CF by using laser diffraction particle size distribution measurement device (by Microtrac BEL Corp., MT3300EXII-SDC). Specifically, respective assisting materials were added to water, ethanol was further mixed therewith before measurement, a three-frequency ultrasonic cleaner (by AS ONE CORPORATION, VS-100III) was used to perform ultrasonic treatment for 5 minutes, and the particle size distribution measurement was performed by using the above device.

Nitrogen adsorption/desorption measurement was performed on the obtained CF by using a specific surface area and pore distribution measurement device (BELSORP MAX, by MicrotracBEL Corp.) under conditions at −196 °C and a relative pressure P/P0=0.99. Before measurement, degassing treatment for vacuum drying was performed on the measurement sample at 150 °C for 6 hours. The equilibrium judgment condition in measuring the pressure in the sample tube was set to 300 seconds. The BET specific surface area S (m²/g) was found by using the BET method from the obtained nitrogen adsorption/desorption isotherm.

The obtained nitrogen adsorption/desorption isotherm was analyzed by using software Autosorb 1 (by Anton Paar Japan K.K.), and in a case of I-type adsorption/desorption isotherm, the pore diameter distribution was analyzed to find the total pore volume with reference to a kernel calculated by the density functional theory (DFT method) assuming a slit type hole. Further, in a case of IV-type adsorption/desorption isotherm, the pore diameter distribution was analyzed to find the total pore volume V (cc/g) by applying the Barrett-Joyner-Halenda method (BJH method) to respective adsorption/desorption isotherms.

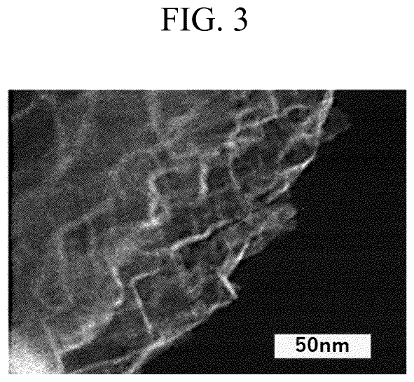

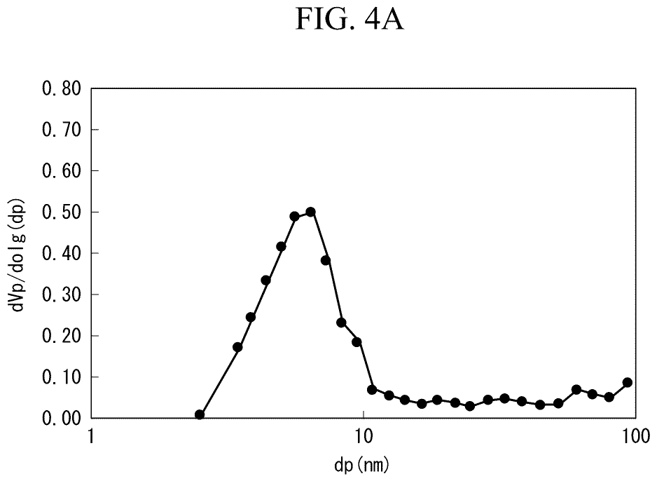

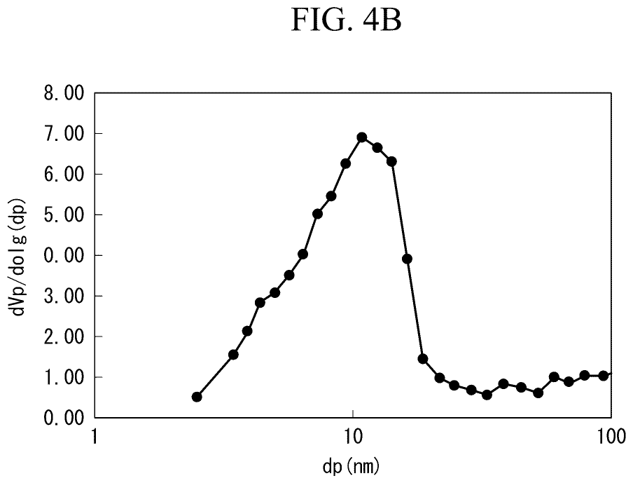

As a result of the measurement, the average particle size of the obtained CF was 2.4 μm, the specific surface area was 997 m²/g, and the total pore volume was 2.25 cc/g. FIG. 3 represents the TEM image of the obtained CF. FIG. 4A illustrates the pore distribution of magnesium oxide nano-powder used as the template ceramic particles (peak pore diameter: 7 nm), and FIG. 4B illustrates the pore diameter distribution curve of the obtained CF. The pore diameter was calculated by fitting the pore diameter distribution with a Gaussian function.

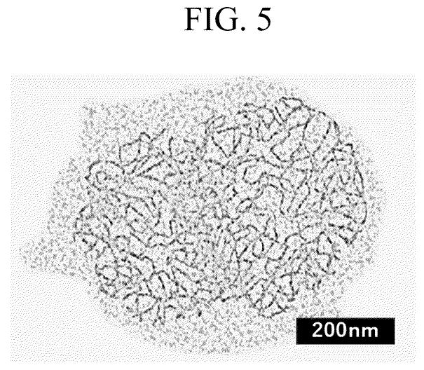

Next, the CF was loaded in a tube-type reaction container, the inside thereof is replaced with a nitrogen gas, and the temperature thereof was raised to 450 °C. A gas including 4% by mol of silane (SiH₄) mixed to a nitrogen gas was then allowed to flow at 200 cc/min under the atmospheric pressure for 130 minutes, and silicon was deposited on the CF. After cooling, the product was taken out and subjected to a crushing and classification process, and the CFSI anode material was obtained. As a result of chemical analysis, the silicon ratio (Si ratio) in 1 g of the material was 71.2%. FIG. 5 represents the TEM image of the obtained CFSI anode material.

Carboxymethyl cellulose (CMC) and styrene-butadiene rubber (SBR) were dissolved and mixed in water so as to obtain the ratio of 68 parts by weight of CFSI anode material, 10 parts by weight of the conductive agent (by Denka Company Limited, product name: DENKA BLACK), 12 parts by weight of CMC, and 10 parts by weight of SBR (by JSR) in a dry state, and water was further added to produce slurry. This was applied onto a Cu current collector with a thickness of 20 μm and dried at 110 °C, then punched out into Φ15 mm and pressurized at 30 kN into an anode electrode. After the obtained anode electrode was vacuum-dried under vacuum at 120 °C, a polypropylene separator was used with 1M of LiPF₆ solution (mixture solvent of ethylene carbonate (EC): diethyl carbonate (DEC)=1:1) as an electrolyte solution in a glove box of an argon gas atmosphere to produce an anode test battery of 2032 type having a metal Li counter electrode.

The test battery was subjected to conduction up to 0.005 V (vs Li/Li⁺) at 0.2 A/g per anode material and charged until the current reached 0.01 A/g. The test battery was then subjected to conduction up to 2.0 V (vs Li/Li⁺) at 0.5 A/g, and discharging was ended. Next, a cycle of the same charging and then discharging was repeated 10 times. For the obtained test battery, the charge and discharge efficiency at the first cycle (1st CE), the first discharge capacity, and the charge and discharge efficiency at the tenth cycle (10th CE) were measured.

### Example 2

As the template of the ceramic particle containing fine pores that is a template, aluminum oxide nano-powder (primary particle size: 8 nm, SSA: 194 m²/g, by Sigma Ardrich) was used to form a carbonaceous film including the graphene structure on the template by a T-CVD method at the heat treatment temperature of 900 °C and a T-CVD method time of 120 minutes. After cooling, the template was taken out and subjected to a crushing and classification process.

Next, the product resulted from the crushing and classification process was treated with hydrofluoric acid to elute the template, the template was washed and dried while the intraparticle space was retained, and thereby a CF precursor was obtained. This was subjected to carbon structure optimization through heat treatment at 1600 °C in an inert atmosphere, and thereby the CF of Example 2 was obtained. Table 1 lists the physical property measurement values of the obtained CF, and FIG. 6A represents a SEM image of the obtained CF. FIG. 6B is a high-resolution SEM image photograph of the surface of the CF obtained in Example 2. FIG. 6C is an ultrahigh-resolution TEM image photograph of the CF obtained in Example 2.

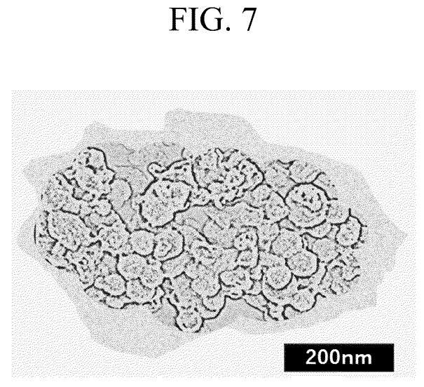

Silicon was then deposited on the CF under the same conditions as in Example 1. After cooling, the product was taken out and subjected to a crushing and classification process, and the CFSI anode material was obtained. As a result of chemical analysis, the Si ratio in 1 g of the material was 71.0%. FIG. 7 represents a TEM image of the obtained CFSI anode material. It is found from FIG. 7 that silicon was attached to the CF and interposed the CF. The anode test battery was then produced under the same conditions as in Example 1, and battery evaluation was performed.

### Example 3

A CF was produced under the same conditions as in Example 1 except that magnesium oxide nano-powder (primary particle size: 0.8 μm, specific surface area (SSA): 90 m²/g, peak pore diameter: 20 nm, by Kyowa Chemical Industry Co., Ltd.) was used as the template having fine pores. Table 1 lists the physical measurement values of the obtained CF. The CFSI anode material was then produced under the same conditions as in Example 1. As a result of chemical analysis, the Si ratio in 1 g of the material was 70.9%. The anode test battery was then produced under the same conditions as in Example 1, and battery evaluation was performed.

### Example 4

A CF was produced under the same conditions as in Example 1 except that silicon dioxide powder (primary particle diameter: 40 nm, specific surface area: 75 m²/g, carbon content: 0 to 1.5%, by NIPPON AEROSIL CO., LTD.) was used as the template of the carbonaceous film. Table 1 lists the physical measurement values of the obtained CF.

The CFSI anode material was then produced under the same conditions as in Example 1. As a result of chemical analysis, the Si ratio in 1 g of the material was 70.6%. The anode test battery was then produced under the same conditions as in Example 1, and battery evaluation was performed.

### Example 5

A CF was produced under the same conditions as in Example 1 except that silicon dioxide powder (primary particle diameter: 60 nm, specific surface area: 55 m²/g, carbon content: 0 to 1.5%, by NIPPON AEROSIL CO., LTD.) was used as the template. Table 1 lists the physical measurement values of the obtained CF.

The CFSI anode material was then produced under the same conditions as in Example 1. As a result of chemical analysis, the Si ratio in 1 g of the material was 71.1%. The anode test battery was then produced under the same conditions as in Example 1, and battery evaluation was performed.

### Example 6

About 8 g of synthetic calcium carbonate NEOLIGHT SA-300 (primary particle diameter: 40 nm, by Takehara Chemical Industrial Co., Ltd.) was spread as the template on a quartz boat, and this quartz boat was set at the center of a quartz reaction tube that is a tube type reaction container. While an argon gas is allowed to flow at a flow rate of 400 mL/min inside the reaction tube, the reaction tube was heated to 550 °C at a temperature rise rate of 10 °C/min. An argon gas was allowed to flow at a flow rate of 320 mL/min, an acetylene gas was allowed to flow at a flow rate of 80 mL/min, that is, at a source gas concentration of 20%, the temperature thereof was maintained at 550 °C for 150 minutes, and CVD treatment was performed. Then, while an argon gas was allowed to flow at a flow rate of 400 mL/min, the temperature thereof was maintained at 900 °C for 120 minutes and then cooled to room temperature, and the product of a template carbonaceous stack was taken out.

The template was then removed to obtain the CF by performing the following operations on the obtained template carbonaceous stack.
(1) About 8 g of the template carbonaceous stack was taken into a glass beaker with a volume of 500 mL, about 40 mL of ultrapure water was added thereto, and the mixture was stirred by a stirrer.
(2) After addition of about 40 mL of 8% (2.3 M) hydrochloric acid, the mixed solution was stirred by the stirrer for 2 hours.
(3) The stirred mixed solution was suction-filtered by using a PTFE membrane filter (Φ90 mm, hole diameter: 1 μm).
(4) The sample left in the beaker was washed with a small amount of ultrapure water for suction filtration.
(5) The sample on the filter was collected into the original glass beaker, and the operations of (2) to (4) were repeated.
(6) Ultrapure water was added to a filter and left standing for 5 minutes, and suction filtration was then performed.
(7) The operation of (6) was repeated until the filtrate was confirmed to be neutral by using pH test paper.
(8) The sample left on the filter paper was collected into the beaker and dried overnight in a dryer at 200 °C to obtain the CF.

The CFSI anode material was then obtained under the same conditions as in Example 1. As a result of chemical analysis, the Si ratio in 1 g of the material was 70.2%. The anode test battery was produced under the same conditions as in Example 1, and battery evaluation was performed.

### Example 7

A CF was produced under the same conditions as in Example 6 except that synthetic calcium carbonate (NEOLIGHT SA-200; primary particle diameter: 40 nm, by Takehara Chemical Industrial Co., Ltd.) was used as the template.

Silicon was then deposited on the CF under the same conditions as in Example 1. After cooling, the product was taken out and subjected to a crushing and classification process, and the CFSI anode material was obtained. As a result of chemical analysis, the Si ratio in 1 g of the material was 71.0%. The anode test battery was then produced in the same manner as in Example 1, and battery evaluation was performed.

### Comparative Example 1

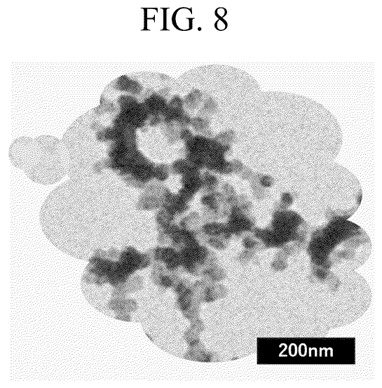

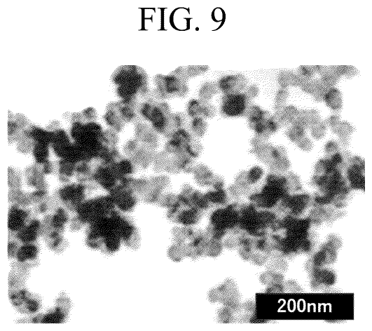

An Si anode material was produced under the same conditions as in Example 1 except that a granulated crushed material of acetylene black (DENKA BLACK Li100, average particle size: 24 μm, specific surface area: 68 m²/g, total pore volume: 0.26 cc/g, a TEM image is in FIG. 9) instead of the CF of Example 1 was used. As a result of chemical analysis, the Si ratio in 1 g of the obtained Si anode material was 69.7%. FIG. 8 represents a TEM image of the obtained anode material. The anode test battery was then produced under the same conditions as in Example 1, and battery evaluation was performed.

### [Experiment 2: Study of Manufacturing Method of CFSI Anode Material]

### Example 8

The CF of Example 1 was loaded in a tube type reaction container, the inside of the reaction container was evacuated, and the temperature thereof was then raised to 450 °C. A gas including 4% by mol of silane mixed with a nitrogen gas was then introduced, and the pressure thereof was returned to the atmospheric pressure. The silane mixture gas was then allowed to flow under the atmospheric pressure at 400 cc/min for 180 minutes, and silicon was deposited on the CF. After cooling, the product was taken out and subjected to a crushing and classification process, and the CFSI anode material was obtained. As a result of chemical analysis, the Si ratio in 1 g of the material was 71.7%. The anode test battery was then produced under the same conditions as in Example 1, and battery evaluation was performed. Table 2 lists the result of battery evaluation.

### Example 9

The CF of Example 1 was loaded in a tube type reaction container, and the temperature thereof was then raised to 450 °C. A gas including 4% by mol of silane mixed with a nitrogen gas was then introduced, the silane mixture gas was allowed to flow under the atmospheric pressure at 400 cc/min for 180 minutes, and silicon was deposited on the CF. Then, while an argon gas was allowed to flow inside the reaction tube at a flow rate of 400 mL/min, the reaction tube was heated to 600 °C. Subsequently, a mixed gas of an argon gas at a flow rate of 360 mL/min and an acetylene gas at a flow rate of 90 mL/min, that is, at a source gas concentration of 20% by volume was allowed to flow for 45 minutes while the temperature thereof was maintained at 600 °C, and a barrier layer (BL) that is a carbonaceous film including the graphene structure was formed on silicon by a T-CVD method to obtain a CFSI anode material. After cooling to room temperature, the product was taken out. As a result of chemical analysis, the Si ratio in 1 g of the obtained Si anode material was 70.4%. The anode test battery was then produced under the same conditions as in Example 1, and battery evaluation was performed. Table 2 lists the result of battery evaluation.

### Example 10

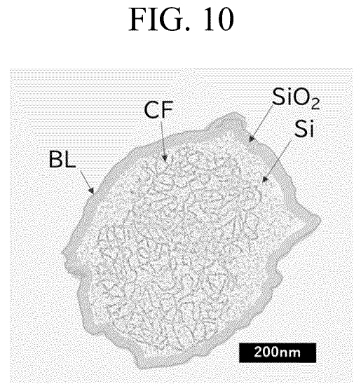

After a crushing and classification process was performed on the CFSI anode material produced under the conditions in Example 1, heat treatment was performed at 300 °C for 5 hours in air current, the air was then replaced with argon atmosphere, and the temperature was raised and maintained at 600 °C while argon was allowed to flow. Subsequently, after a mixed gas of an argon gas and an acetylene gas (a source concentration of 20% by volume) was allowed to flow for 45 minutes, a barrier layer (BL) that is carbonaceous film containing the graphene structure was subjected to oxidation treatment by a T-CVD method to obtain the CFSI anode material formed on silicon where the oxide layer was formed on the surface. As a result of chemical analysis, the Si ratio in 1 g of the CFSI anode material was 70.1%. FIG. 10 represents a TEM image. Further, it was confirmed that the content of oxygen was 1.3% by SEM-EDX analysis. Accordingly, it was confirmed that oxide of silicon was produced. The anode test battery was then produced under the same conditions as in Example 1, and battery evaluation was performed. Table 2 lists the result of battery evaluation.

### Example 11

After a crushing and classification process was performed on the CFSI anode material produced under the conditions in Example 1, heat treatment was performed at 300 °C for 5 hours in air current, the air was then replaced with argon atmosphere, and the temperature thereof was raised and maintained at 600 °C while argon was allowed to flow. Subsequently, after a mixed gas of an argon gas and an acetylene gas (a source concentration of 20% by volume) was allowed to flow for 45 minutes, a barrier layer (BL) that is carbonaceous film containing the graphene structure was subjected to oxidation treatment by a T-CVD method to obtain the CFSI anode material formed on silicon where the oxide layer was formed on the surface. After cooling, the obtained product was taken out and subjected to a crushing and classification process.

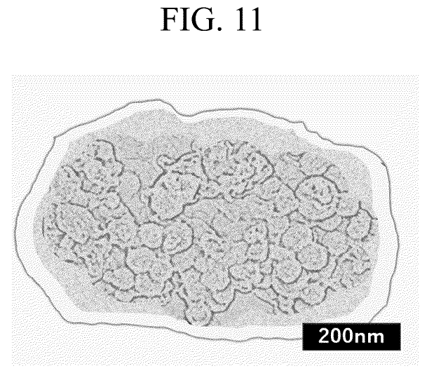

Next, the product resulted from the crushing and classification process was treated by hydrofluoric acid to elute an oxide layer, the oxide layer was washed and dried, and a CFSI anode material having a barrier layer void (BLV) between the BL and the silicon surface was obtained. FIG. 11 represents a TEM image of the obtained CFSI anode material. As a result of chemical analysis, the Si ratio in 1 g of the material was 69.7%. The anode test battery was then produced under the same conditions as in Example 1, and battery evaluation was performed. Table 2 lists the result of battery evaluation.

### Example 12

Silicon was deposited on the CF under the same conditions as in Example 1 except that the CF precursor was not subjected to the heat treatment at 1600 °C in an inert atmosphere and used as the CF in the conditions in Example 1. After cooling, the product was taken out and subjected to a crushing and classification process, and a CFSI anode material was obtained. As a result of chemical analysis, the Si ratio in 1 g of the material was 71.9%. The anode test battery was then produced under the same conditions as in Example 1, and battery evaluation was performed. Table 2 lists the result of battery evaluation.

### Example 13

Isostatic press was applied to the CF obtained in Example 5 (pore peak diameter: 47 nm) to obtain a CF resulted from a pore compression process (pore peak diameter: 8 nm). Except that this is used as a CF, silicon was deposited on the CF under the same condition as in Example 1. After cooling, the product was taken out and subjected to a crushing and classification process, and a CFSI anode material was obtained. As a result of chemical analysis, the Si ratio in 1 g of the CFSI anode material was 71.3%. The anode test battery was then produced under the same conditions as in Example 1, and battery evaluation was performed. Table 2 lists the result of battery evaluation.

### [Experiment 3: Study of Aspect Ratio of CF Particle]

### Example 14

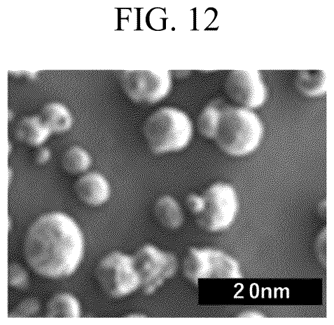

Fine pore-containing template ceramic particles that are the same templates as the templates used in Example 2 were granulated into a substantially spherical shape by a rotary granulation device to obtain substantially spherical granulated particles. In other respects, the CF was produced under the same conditions as in Example 2. FIG. 12 represents a SEM image of the obtained CF. It was found from the image that the particles exhibit substantially spherical shape having various particle diameters. These granulated particles were cracked and classified, and the measured average aspect ratio was 1.1. Note that the average aspect ratio of the CF of Example 2 was 3.1.

Silicon was then deposited on the CF under the same conditions as in Example 1. After cooling, the product was taken out and subjected to a crushing and classification process, and a CFSI anode material was obtained. As a result of chemical analysis, the average particle size of the obtained CFSI anode material was 6.5 μm, and the Si ratio in 1 g of the material was 71.8%. The anode test battery was then produced under the same conditions as in Example 1, and battery evaluation was performed. Table 3 lists the result of battery evaluation.

### Example 15

The granulated particles obtained under the conditions in Example 14 were cracked and classified with different conditions, and the CF having the average aspect ratio of 1.5 was obtained. Silicon was then deposited on the CF under the same condition as in Example 1. After cooling, the product was taken out and subjected to a crushing and classification process, and a CFSI anode material was obtained. As a result of chemical analysis, the Si ratio in 1 g of the obtained CFSI anode material was 71.6%. The anode test battery was then produced under the same conditions as in Example 1, and battery evaluation was performed. Table 3 lists the result of battery evaluation.

### Example 16

The granulated particles obtained under the conditions in Example 14 were cracked and classified with different conditions, and the CF having the average aspect ratio of 2.1 was obtained. Silicon was then deposited on the CF under the same condition as in Example 1. After cooling, the product was taken out and subjected to a crushing and classification process, and a CFSI anode material was obtained. As a result of chemical analysis, the Si ratio in 1 g of the obtained CFSI anode material was 71.4%. The anode test battery was then produced under the same conditions as in Example 1, and battery evaluation was performed. Table 3 lists the result of battery evaluation.

### Example 17

The granulated particles obtained under the conditions in Example 14 were cracked and classified with different conditions, and the CF having the average aspect ratio of 4.5 was obtained. Silicon was then deposited on the CF under the same condition as in Example 1. After cooling, the product was taken out and subjected to a crushing and classification process, and a CFSI anode material was obtained. As a result of chemical analysis, the Si ratio in 1 g of the obtained CFSI anode material was 71.3%. The anode test battery was then produced under the same conditions as in Example 1, and battery evaluation was performed. Table 3 lists the result of battery evaluation.

### Example 18

The granulated particles obtained under the conditions in Example 14 were cracked and classified with different conditions, and the CF having the average aspect ratio of 5.3 was obtained. Silicon was then deposited on the CF under the same condition as in Example 1. After cooling, the product was taken out and subjected to a crushing and classification process, and a CFSI anode material was obtained. As a result of chemical analysis, the Si ratio in 1 g of the obtained CFSI anode material was 71.2%. The anode test battery was then produced under the same conditions as in Example 1, and battery evaluation was performed. Table 3 lists the result of battery evaluation.

### RESULT AND CONCLUSION

Table 1 lists results of battery evaluation performed on anode test batteries (lithium-ion batteries) obtained in Examples 1 to 7 and Comparative example 1.

TABLE 1

| | | | | | | | | | | Cycle |
|---|---|---|---|---|---|---|---|---|---|---|
| | Frame structure (CF) physical property | | | | | | Initial charge/discharge capacity | | | characteristics |
| | Specific | | | | | CFSI | | | Initial charge/ | 10th cycle |
| | surface | Average | Pore | Oil | Effective | average | Charge | Discharge | discharge | capacity |
| | area | particle | volume | absorption | spatial | particle | capacity | capacity | efficiency | retention rate |
| | (m²/g) | size (μm) | (cc/g) | (cc/g) | index | size (μm) | (mAh/g) | (mAh/g) | (%) | (%) |
| Example 1 | 997 | 2.4 | 2.25 | 5.77 | 2.56 | 3.0 | 3352 | 2390 | 71.3% | 96.3% |
| Example 2 | 1950 | 5.7 | 2.60 | 4.07 | 1.57 | 6.1 | 2891 | 2350 | 81.3% | 99.0% |
| Example 3 | 750 | 3.1 | 2.56 | 4.90 | 1.91 | 3.5 | 2935 | 2260 | 77.0% | 96.5% |
| Example 4 | 997 | 8.2 | 4.35 | 18.70 | 4.30 | 9.5 | 3185 | 2389 | 75.0% | 89.7% |
| Example 5 | 1204 | 10.5 | 5.90 | 22.80 | 3.86 | 10.5 | 3238 | 2406 | 74.3% | 88.2% |
| Example 6 | 884 | 7.8 | 3.52 | 13.50 | 7.99 | 11.7 | 3082 | 2305 | 75.2% | 88.4% |
| Example 7 | 586 | 8.5 | 1.85 | 18.92 | 10.22 | 18.2 | 2957 | 2200 | 74.3% | 85.2% |
| Comparative | 68 | 1.2 | 0.26 | 3.05 | 11.78 | 2.0 | 2812 | 1960 | 70.2% | 82.0% |
| Example 1 | | | | | | | | | | |

Table 2 lists results of battery evaluation performed on anode test batteries obtained in Examples 8 to 13.

TABLE 2

| | Initial charge/discharge capacity | | | Cycle |
|---|---|---|---|---|
| | | | Initial | characteristics |
| | | | charge/ | 10th cycle |
| | Charge | Discharge | discharge | capacity |
| | capacity | capacity | efficiency | retention |
| | (mAh/g) | (mAh/g) | (%) | rate (%) |
| Example 1 | 3352 | 2390 | 71.3% | 96.3% |
| Example 8 | 3371 | 2410 | 71.5% | 96.7% |
| Example 9 | 3019 | 2243 | 74.3% | 97.1% |
| Example 10 | 2843 | 2107 | 79.8% | 97.9% |
| Example 11 | 2906 | 2078 | 80.2% | 98.0% |
| Example 3 | 2935 | 2260 | 77.0% | 96.5% |
| Example 12 | 3014 | 2336 | 77.5% | 96.8% |
| Example 5 | 3238 | 2406 | 74.3% | 88.2% |
| Example 13 | 3057 | 2354 | 77.1% | 97.2% |

Table 3 lists results of battery evaluation performed on anode test batteries obtained in Examples 14 to 18.

TABLE 3

| | Frame structure physical | | | | | |
|---|---|---|---|---|---|---|
| | property | | Initial charge/discharge capacity | | | |
| | Average | Average | Charge | Discharge | Initial charge/ | Cycle characteristics |
| | particle size | aspect ratio | capacity | capacity | discharge | 10th cycle capacity |
| | (μm) | (—) | (mAh/g) | (mAh/g) | efficiency (%) | retention rate (%) |
| Example 2 | 5.7 | 3.1 | 2891 | 2350 | 81.3% | 99.0% |
| Example 14 | 5.3 | 1.1 | 2831 | 2361 | 83.4% | 99.7% |
| Example 15 | 6.1 | 1.5 | 2844 | 2358 | 82.9% | 99.5% |
| Example 16 | 5.8 | 2.1 | 2851 | 2355 | 82.6% | 99.3% |
| Example 17 | 6.3 | 4.5 | 2901 | 2350 | 81.0% | 98.2% |
| Example 18 | 6.5 | 5.3 | 2910 | 2348 | 80.7% | 95.3% |

As is clear from Table 1, the battery characteristics of the battery with the lithium-ion battery anode material of the present embodiment are better than the battery characteristics of the comparative example. This is due to the differences in the internal structure of the anode material and the physical property called effective spatial index, which is an index of substantial silicon growth spatial structure during silane CVD.

Since all the frame structures of the anode materials contained in the anodes of the anode test batteries of Examples 1 to 7 have the CF arranged inside silicon, these frame structures exhibit high electron conductivity and high flexibility. It is thus considered that the anode materials are likely to follow a change in the form caused by expansion and contraction of silicon, have a high charge and discharge capacity, and also have a high cycle retention rate.

In particular, in the conversion process from silane to silicon, that is, from a gas to a solid, the size of the space and the affinity with the frame structure in a change in the form (wettability) are considered to be important for reaction field formation.

In the step of silane CVD, an organic-like silane gas transforms from organic component-like low-molecular weight polysilane to high-molecular-weight polysilane and then to solid silicon while being thermally decomposed. In such a transformation process, the effective spatial index is controlled in a suitable range, where the effective spatial index is the ratio between a pore volume, which is a measurement value of the gas diffusion pore volume by a gas phase method and an oil absorption, which can be said as a measurement value of a wet permeable space due to a liquid organic substance by a liquid phase method reflected by the organic component-like nature. It is considered that this affected the adhesion of silicon to the frame structure, production control of silicon crystal nucleus, or the like, and thus, the silicon-based anode material indicating characteristics such as a good cycle or initial capacity was realized.

In contrast, when the carbon black granulated crushed substance having no hollow structure as with Comparative example 1 was used as the frame structure arranged inside silicon, the frame structure is unable to follow a change in the form caused by expansion and contraction of silicon during charging and discharging, and structural destruction occurs from the first cycle. It is thus considered that electron conductivity was lost, lithium ions were unable to be released from charged Li—Si, and the initial capacity was reduced. Further, the carbon black used in the battery of Comparative example 1 has lower electron conductivity and poorer flexibility than the CF of the present embodiment. It is thus considered that the reduction in cycle characteristics was increased in the battery of Comparative example 1 as a result of gaining a tendency of an increased electrode resistance with repetition of charging and discharging of the battery.

Table 2 lists the results of study on the manufacturing method of the CFSI anode material of Example 8 to Example 13. In Example 8 employing a method of introducing a silane gas to a deep part inside the CF, the anode material capacity was improved. In Example 9, the silicon surface was covered with the barrier layer, this suppressed the adverse effect that would otherwise be caused by scattering of silicon particles after a structural change due to charging and discharging, and the cycle characteristics were improved.

In Example 10, a part of silicon was oxidized, hard silicon oxide was introduced, further covered with the barrier layer, and thereby the cycle characteristics were improved. In Example 11, silicon oxide was removed from the CFSI of Example 10, thereby the barrier layer void was provided, the impact of volumetric increase during expansion of silicon was able to be mitigated, and the cycle characteristics were improved.

A highly optimized anode material can be provided by selecting a manufacturing method in accordance with applications as a battery, operation conditions, or required characteristics.

Table 3 lists the results of improvement on the average aspect ratio, which is a particle physical property of the CF that is a member of the silicon-based anode material for application to the practical electrode.

The average aspect ratio indicating three-dimensional anisotropy is a factor contributing to the anisotropy when silicon is alloyed with Li and expanded. A smaller average aspect ratio of the CF results in more isotropic expansion of CFSI particles, and the impact of the expansion is smaller. It is considered that the cycle characteristics or the like becomes better as a result.

The frame structure of the present invention has a pore that is a through hole or a bottomed hole on the surface of the frame and may include one or a plurality of the following configurations of (1) to (7): (1) the configuration made of at least one of a carbonaceous substance, a graphene substance, and a thin-layer graphene substance, (2) the configuration having an outer shell made of at least one of a plate-like shape, a curved surface shape, and an irregular surface shape, (3) the configuration of the average particle size of frame structure particles being greater than or equal to 1.3 μm and less than or equal to 10.5 μm, (4) the configuration of the effective spatial index obtained by dividing a pore volume of the frame structure by an oil absorption being 1.5 to 10.5, (5) the configuration of at least a part of the frame structure being a spherical or substantially spherical particle, (6) the configuration of the frame structure being a particle and the average aspect ratio of the particle being 1 to 5, and (7) the configuration formed of at least one of carbon meso-sponge and graphene meso-sponge.

The lithium-ion battery anode material of the present invention includes silicon and a frame structure formed of a carbon material, has a pore that is a through hole or a bottomed hole in the surface of the frame of the frame structure, and may include one or a plurality of the following configurations of (8) to (11): (8) the configuration of at least a part of the frame structure being interposed by silicon; (9) the configuration of the silicon including silicon oxide; (10) the configuration having one or more barrier layers made of any of a carbonaceous substance, a graphene substance, and a thin-layer graphene substance outside the surface of the silicon; and (11) the configuration having a void layer between the barrier layer and the outer surface of the silicon.

In the lithium-ion battery anode of the present invention, the contained lithium-ion battery anode material includes silicon and a frame structure formed of a carbon material and has pores that are through holes or bottomed holes in the surface of the frame of the frame structure, and the lithium-ion battery anode material may include one or a plurality of the configurations of (8) to (11) described above.

The present invention is not limited to the embodiment or Examples described above. Forms with design changed in various ways within the scope without departing from the scope of the present invention are included in the present invention.

### REFERENCE SIGNS LIST

CF core frame structure
BL barrier layer
BLV barrier layer void (void layer)
Si silicon
200 lithium-ion battery
211 exterior component
212 cathode
213 exterior component
214 anode
215 separator
217 sealing gasket
218 spring
219 spacer

1. A lithium-ion battery anode material member used for a frame arranged inside silicon of a lithium-ion battery anode material,
wherein the anode material member is a carbon material forming a frame structure serving as a core, and
wherein a surface of a frame of the frame structure has a pore in, the pore being a through hole or a bottomed hole, and
wherein the frame structure has an outer shell comprising at least one of a plate-like shape, a curved face shape, and an irregular surface shape.

2-4. (canceled)

5. The lithium-ion battery anode material member according to claim 1, wherein the effective spatial index defined as the pore volume of the frame structure divided by an oil absorption is 1.5 to 10.5.

6. The lithium-ion battery anode material member according to claim 1, wherein at least a part of the frame structure is spherical or substantially spherical particles.

7. The lithium-ion battery anode material member according to claim 1, wherein the frame structure are particles, and an average aspect ratio of the particles is 1 to 5.

8. The lithium-ion battery anode material member according to claim 1, wherein the frame structure is formed of at least one of carbon meso-sponge and graphene meso-sponge.

9. A manufacturing method of a lithium-ion battery anode material member according to claim 1, the manufacturing method comprising steps of:
arranging ceramic particles serving as a template;
circulating organic hydrocarbon and coating a carbon layer or a graphene layer on a surface of the ceramic particles by a chemical vapor deposition (CVD) method;
dissolving and eluting the ceramic particles with acid and forming a frame structure precursor having an intraparticle space; and
applying heat treatment to the obtained frame structure precursor to obtain a frame structure,
wherein a surface of a frame of the frame structure has a pore, the pore being a through hole or a bottomed hole.

10. The manufacturing method of the frame structure according to claim 9, wherein each of the ceramic particles includes a pore inside.

11. The manufacturing method of the frame structure according to claim 9 further comprising a step of granulating each of the ceramic particles into a substantially spherical shape before the step of coating the carbon layer or the graphene layer.

12. (canceled)

13. The manufacturing method of the frame structure according to claim 9, wherein a pore compression process is performed after the step of obtaining the frame structure.

14. A lithium-ion battery anode material comprising:
silicon; and
a lithium-ion battery anode material member according to claim 1.

15-16. (canceled)

17. The lithium-ion battery anode material according to claim 14, wherein the lithium-ion battery anode material has one or more barrier layers outside the surface of the silicon, the barrier layers comprising any of a carbonaceous substance, a graphene substance, and a thin-layer graphene substance.

18. The lithium-ion battery anode material according to claim 17, wherein the lithium-ion battery anode material has a layer void between the barrier layer and the outer surface of the silicon.

19. A manufacturing method of lithium-ion battery anode material according to claim 14 comprising steps of:
arranging a frame structure serving as a core in a reaction container, the frame structure being a carbon material; and
circulating a compound containing silicon at 300 °C to 900 °C in the reaction container and depositing silicon on an outer surface of the frame structure by a CVD method.

20-21. (canceled)

22. The manufacturing method of lithium-ion battery anode material according to claim 19 further comprising steps of: after the step of arranging the frame structure,
vacuum-suctioning the reaction container into a vacuum state; and
raising the temperature of the reaction container to a temperature at which a CVD reaction is performed,
wherein CVD is performed after a mixed gas of a gaseous silane diluted with an inert gas is introduced into the reaction container under the vacuum state.

23. The manufacturing method of lithium-ion battery anode material according to claim 22, wherein the CVD is performed while the mixed gas is circulated.

24. The manufacturing method of lithium-ion battery anode material according to claim 19, wherein a barrier layer comprising any of a carbonaceous substance, a graphene substance, and a thin-layer graphene substance is formed outside the surface of the deposited silicon.

25. The manufacturing method of lithium-ion battery anode material according to claim 19 further comprising steps of:
heating the frame structure at 200 °C to 500 °C in an atmosphere containing at least oxygen after depositing silicon on the outer surface of the frame structure to contain oxide in the silicon;
replacing content in the reaction container with an inert gas; and
forming a barrier layer on outside of the surface of silicon containing the oxide under circulation of a gas of a compound containing carbon, the barrier layer comprising any of a carbonaceous substance, a graphene substance, and a thin-layer graphene substance.

26. The manufacturing method of lithium-ion battery anode material according to claim 19 further comprising steps of:
providing an oxide layer on the outer surface of the deposited silicon after the step of depositing silicon on the outer surface of the frame structure;
forming a barrier layer on the outer surface of the oxide layer by a CVD method using a hydrocarbon gas, the barrier layer comprising any of a carbonaceous substance, a graphene substance, and a thin-layer graphene substance; and
forming a layer void between the barrier layer and the outer surface of the deposited silicon by dissolving and eluting the oxide layer with acid.

27. A lithium-ion battery anode including the lithium-ion battery anode material according to claim 14.
